(19) United States
(12) Patent Application Publication
(10) Pub. No.: US 2026/0187638 A1
(43) Pub. Date: Jul. 2, 2026

(54) COMPUTER SYSTEMS AND METHODS FOR QUALITY REVIEW OF INVESTIGATOR DECISIONS

(71) Applicant: Capital One Financial Corporation, McLean, VA (US)

(72) Inventors: Sonal Jain, Jersey City, NJ (US); Van Vo, Manvel, TX (US); Fang Bai, Buffalo Grove, IL (US)

(21) Appl. No.: 19/006,766

(22) Filed: Dec. 31, 2024

(51) Int. Cl. G06Q 20/40; G06N 20/00

(52) U.S. Cl. CPC G06Q 20/4016; G06N 20/00

(57) ABSTRACT

A computing platform is configured to: (i) receive an indication of a given investigator decision of whether or not given transaction activity is suspicious; (ii) load source data for use in predicting whether the given transaction activity is suspicious; (iii) based on the loaded source data, prepare feature data for an AI model framework that is configured to predict whether transaction activity underlying an investigator decision is suspicious; (iv) input the feature data into the AI model framework and thereby cause the AI model framework to generate and output a prediction of whether or not the given transaction activity is suspicious; (v) determine that there is a mismatch between (a) the given investigator decision and (b) the prediction of whether or not the given transaction activity is suspicious; and (vi) based on the determination, flag the given investigator decision for quality review.

### BACKGROUND

It is becoming increasingly important for financial institutions to monitor for suspicious activity that may be occurring in connection with financial transactions, such as payment card transactions, transfers, deposits, withdrawals, peer-to-peer (P2P) transactions, electronic check transactions, etc. Such suspicious activity may take various forms, such as fraud (e.g., check fraud, credit card fraud, kiting, loan fraud, etc.), racketeering, embezzlement, money laundering, terrorism financing, identity theft, trafficking (e.g., drug trafficking, human trafficking, etc.), tax evasion (e.g., cash transaction structuring, etc.), bribery, extortion, and insider trading, among other possibilities. The consequences of such suspicious activity may take various forms for financial institutions, such as monetary losses (e.g., lost revenue for financial institutions, lost savings for consumers, etc.), loss of customers, reputational damage, violation of laws or regulations, government fines, and even bankruptcy, among other possibilities. Furthermore, the consequences of such suspicious activity within society may extend well beyond the damage suffered by financial institutions. Individuals may lose their life savings, organized crime syndicates may be empowered to operate with impunity, terrorist organizations may be strengthened, and, in severe cases, the very stability of national financial systems and/or governments may be threatened, among other possibilities.

### OVERVIEW

Disclosed herein is new software technology that utilizes an artificial intelligence (AI) model framework to evaluate investigator decisions (i.e., decisions of whether or not certain transaction activity is suspicious) for purposes of determining whether or not to flag the investigator decisions for quality review and then causes the flagged investigator decisions to be presented to quality-review analysts.

In one aspect, the disclosed technology may take the form of a method to be carried out by a computing platform that involves (i) receiving an indication of a given investigator decision of whether or not given transaction activity is suspicious; (ii) loading source data for use in predicting whether the given transaction activity is suspicious; (iii) based on the loaded source data, preparing feature data for an AI model framework that is configured to predict whether transaction activity underlying an investigator decision is suspicious; (iv) inputting the feature data into the AI model framework and thereby causing the AI model framework to generate and output a prediction of whether or not the given transaction activity is suspicious; (v) determining that there is a mismatch between (a) the given investigator decision of whether or not the given transaction activity is suspicious and (b) the prediction of whether or not the given transaction activity is suspicious; and (vi) based on the determination, flagging the given investigator decision for quality review.

In some examples, preparing the feature data for the AI model framework involves (i) generating structured feature data comprising values for a first set of structured feature variables that provide information about (a) an account holder involved in the given transaction and (b) the given investigator decision; and (ii) generating unstructured feature data comprising textual data generated in connection with the given investigator decision.

Further, in some examples, the AI model framework comprises a first AI model and a second AI model, and inputting the feature data into the AI model framework and thereby causing the AI model framework to generate and output the prediction involves (i) inputting the values for the first set of structured feature variables into the first AI model, thereby causing the first AI model to generate and output a first prediction of whether the given transaction activity is suspicious; and (ii) inputting the textual data into the second AI model, thereby causing the second AI model to generate and output a second prediction of whether the given transaction activity is suspicious.

Still further, in some examples, inputting the feature data into the AI model framework and thereby causing the AI model framework to generate and output the prediction involves combining the first prediction and the second prediction into a combined prediction.

Still further, in some examples, preparing the feature data for the AI model framework comprises generating structured feature data comprising values for a second set of structured feature variables that provide information about the account holder involved in the transaction, but do not provide information about the given investigator decision.

Still further, in some examples, the AI model framework comprises a third AI model, and inputting the feature data into the AI model framework and thereby causing the AI model framework to generate and output the prediction involves inputting the values for the second set of structured feature variables into the third AI model, thereby causing the third AI model to generate and output a third prediction of whether the given transaction activity is suspicious.

Still further, in some examples, the third prediction is the prediction of whether or not the given transaction activity is suspicious, and determining that there is a mismatch between (i) the given investigator decision of whether or not the given transaction activity is suspicious and (ii) the prediction of whether or not the given transaction activity is suspicious involves (a) determining that there is a match between (i) the given investigator decision of whether or not the given transaction activity is suspicious and (ii) the combined prediction; and (b) determining that there is a mismatch between (i) the combined prediction and (ii) the third prediction.

In yet another aspect, disclosed herein is a computing platform that includes a communication interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In still another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 an example network environment in which aspects of the disclosed software technology disclosed herein can be implemented.

FIG. 2 depicts a block diagram of an example software-based pipeline that carries out functionality disclosed herein.

FIG. 3 is a block diagram of an example architecture of an investigator-decision-analysis component that may be included in the software-based pipeline of FIG. 2, according to one illustrative example.

FIG. 4 depicts representative examples of pre-processed versions of investigator notes for investigator decisions, according to one illustrative example.

FIG. 5 is a flow chart of example of functionality that may be carried out in accordance with the software technology disclosed herein.

FIG. 6 depicts a simplified block diagram to illustrate some structural components that may be included in an example computing platform that may be configured to perform some or all of the platform functions disclosed herein.

FIG. 7 depicts a simplified block diagram to illustrate some structural components that may be included in an example client device that may be configured to perform some or all of the client-device functions disclosed herein.

### DETAILED DESCRIPTION

As noted above, it is becoming increasingly important for financial institutions to monitor for suspicious activity that may be occurring in connection with financial transactions, such as payment card transactions, transfers, deposits, withdrawals, peer-to-peer (P2P) transactions, electronic check transactions, etc. Such suspicious activity may take various forms, such as fraud (e.g., check fraud, credit card fraud, kiting, loan fraud, etc.), racketeering, embezzlement, money laundering, terrorism financing, identity theft, trafficking (e.g., drug trafficking, human trafficking, etc.), tax evasion (e.g., cash transaction structuring, etc.), bribery, extortion, and insider trading, among other possibilities. The consequences of such suspicious activity may take various forms for financial institutions, such as monetary losses (e.g., lost revenue for financial institutions, lost savings for consumers, etc.), loss of customers, reputational damage, violation of laws or regulations, government fines, and even bankruptcy, among other possibilities. Furthermore, the consequences of such suspicious activity within society may extend well beyond the damage suffered by financial institutions. Individuals may lose their life savings, organized crime syndicates may be empowered to operate with impunity, terrorist organizations may be strengthened, and, in severe cases, the very stability of national financial systems and/or governments may be threatened, among other possibilities.

Given the significance of these consequences, it is important for financial institutions to monitor transactions involving the financial accounts they maintain in order to identify transaction activity that appears to be suspicious and then take action to avoid or remedy such suspicious transaction activity. However, given the large volume of transactions that are now processed each day, it is not practically possible for financial institutions to have their employees review transactions for potentially suspicious activity. As such, technology has been developed to help financial institutions identify transaction activity that is likely to be suspicious in nature. For instance, software technology has been developed that functions to (i) monitor transactions in real time for potential suspicious activity by evaluating information about the transactions and the account holders involved in the transactions (i.e., the financial institution's customers) and (ii) generate alerts for suspicious transaction activity, which could be based on a single transaction or a set of multiple transactions (e.g., multiple transactions involving a same account holder). This technology is often referred to as “transaction monitoring” software, and one representative example of such transaction monitoring software is the Suspicious Activity Monitoring (SAM) software offered by NICE Actimize, although various other examples of transaction monitoring software exist as well.

While the existing transaction monitoring technology makes it practically possible for financial institutions to monitor transactions for potentially suspicious activity, the existing transaction monitoring technology is designed to err on the side of caution when determining whether or not transaction activity appears to be suspicious, which means that the existing transaction monitoring technology typically generates alerts for certain transaction activity that is not actually suspicious in nature. These types of alerts are commonly referred to as “false positives,” and may lead various other negative consequences—including the unnecessary blocking of legitimate transactions as well as other wasted resources addressing the false positives.

Various other technology has been developed to deal with the false positives that are produced by transaction monitoring software. For instance, advancements have been made to the existing transaction monitoring software so as to allow financial institutions to create and implement customized rules for handling transaction activity that is identified as potentially being suspicious, which may allow financial institutions to reduce the extent of false positives that are output by the transaction monitoring software. However, it is generally not possible to eliminate false positives entirely using such customizable rules. As such, technology has also been developed that facilitates a further human review of the transaction activity that is identified by transaction monitoring software.

For instance, software applications have been developed that function to load the alerts generated by transaction monitoring software and then present such alerts to individuals that are tasked with reviewing and validating that the transaction activity underlying those alerts is truly suspicious in nature. These individuals are sometimes referred to as “investigators,” and within a financial institution, such investigators are sometimes considered to be part of a team referred to as the “Financial Investigation Unit” (FIU). Using such a software application, an investigator may review transaction activity that was identified by transaction monitoring software as potentially involving suspicious activity and then input an indication of whether or not the investigator believes that each reviewed transaction activity is truly suspicious, which may be referred to as an “investigator decision” for the transaction. Additionally, along with inputting the indication of the investigator decision, the investigator may also provide other associated input regarding the investigator decision, such as notes regarding the investigator decision (e.g., notes that include facts considered and/or reasoning applied to reach the investigator decision).

The financial institution may then utilize the investigator decisions to generate and file a Suspicious Activity Reports (SAR), which is a document that financial institutions are required by law to file (e.g., under the Bank Secrecy Act (BSA)) with the Financial Crimes Enforcement Network (FinCEN, which is a division of the U.S. Department of the Treasury) within thirty days for a transaction that is suspected to involve certain types of suspicious activity (e.g., fraud, money laundering, terrorist financing, etc.). A SAR includes information such as the identities of parties to the suspicious transaction(s) and/or other entities involved in the transaction(s), the nature of the transaction(s), the monetary amount(s) involved in the transaction(s), and/or reasons why a suspicious activity is suspected with respect to the transaction(s). A SAR also may include a narrative section where an explanation of the suspicious activity is to be provided.

While the technology that facilitates investigator reviews of transaction activity identified by transaction monitoring software as potentially being suspicious is helpful for removing false-positive alerts and for identifying true-positive alerts for which to file SARs as mandated by law, there are still various problems that can arise in the process of monitoring for, identifying, and reporting transaction activity that appears to be suspicious. For instance, investigator review of transaction activity identified by transaction monitoring software can still result in incorrect, inconsistent, and/or incomplete classifications of transaction activity due to human error, which can lead to low-quality SARs as well as potential missed SARs, both of which give rise to a host of negative consequences.

In order to protect against the possibility of incorrect, inconsistent, and/or incomplete investigator decisions and the problems that come with them, there have been some efforts to develop technology for reviewing and validating investigator decisions for correctness, consistency, and/or completeness, which may be referred to either individually or collectively as the “compliance” of the investigator decisions. For instance, technology has been developed that involves using a software application to present investigator decisions to individuals that are tasked with reviewing and validating the compliance of the investigator decisions. These individuals are sometimes referred to as quality-review analysts, and within a financial institution, these quality-review analysts are sometimes considered to be part of a team referred to as the “quality review team” or “quality control team.”

Using such a software application, a quality-review analyst may review certain investigator decisions and input an indication of whether or not the quality-review analyst agrees with each reviewed investigator decision (e.g., whether the reviewed investigator decision is considered to be compliant or non-compliant), which may be referred to as a “quality-review conclusion.” And if the quality-review analyst disagrees with an investigator decision, the transaction activity underlying the investigator decision can then be reevaluated to determine whether or not it was actually suspicious, which may avoid some of the negative consequences explained above.

However, in practice, it is typically not possible for quality-review analysts to do an exhaustive review of the full set of investigator decisions that are made. As such, the existing technology for conducting a quality review of investigator decisions currently only presents quality-review analysts with a subset of investigator decisions for further review that are selected at random rather than based on any metric that indicates how likely they are to include errors. This leads to various problems as well. For instance, since the investigator decisions are selected at random for review, the selected investigator decisions are no more likely to have errors than investigator decisions that are not selected. If the majority of investigator decisions do not have errors, then the majority of selected decisions may, on average, also not have errors. As a result, the efforts of quality-review analysts may, on average, be focused on investigator decisions that are unlikely to have errors—thereby resulting in a suboptimal use of the time and resources that quality-review analysts have. This may, in turn, allow more erroneous investigator decisions to remain on file, thereby allowing the problems caused by erroneous investigator decisions (e.g., compliance issues from failures to file SARs, inconsistencies in training data, etc.) to persist.

In view of the foregoing issues with the existing technology for conducting a quality review of investigator decisions, other technology for making a more intelligent selection of investigator decisions to present for quality review has recently been proposed. One example of this proposed technology involves utilizing a data science model that is configured to identify investigator decisions to present for quality review based on information about the investigators themselves, such as the experience level of the investigators. Another example of this proposed technology involves generating and sending a prompt to a large language model (LLM) that asks the LLM to evaluate whether an alert involves suspicious activity and then utilizing the LLM's response as a basis for flagging investigator decisions to present for quality review. However, this proposed technology still tends to miss in both directions—it flags too many investigator decisions for quality review that were compliant and it also fails to flag too many investigator decisions that were non-compliant. Thus, there remains a need for technology that identifies investigator decisions for quality review in an accurate way so as to allow quality-review analysts to focus their efforts on the investigator decisions that are most likely to erroneous and not on investigator decisions that are most likely to be compliant.

To address these and other problems with existing technology, disclosed herein is software technology that utilizes an artificial intelligence (AI) model framework to evaluate investigator decisions (i.e., decisions of whether or not certain transaction activity is suspicious) for purposes of determining whether or not to flag the investigator decisions for quality review and then causes the flagged investigator decisions to be presented to quality-review analysts.

At a high level, the disclosed software technology may be embodied in the form of a software-based pipeline that functions to receive indications of investigator decisions (along with associated investigator-decision data) and then evaluate each respective investigator decision by (i) loading source data for use in predicting whether the transaction activity underlying the respective investigator decision is suspicious, (ii) based on the loaded source data, preparing feature data for an AI model framework that is configured to predict whether the transaction activity underlying the respective investigator decision is suspicious, (iii) inputting the feature data into the AI model framework and thereby causing the AI model framework to generate and output a prediction of whether the transaction activity underlying the respective investigator decision is suspicious, and (iv) based on the prediction, determining whether to flag the respective investigator decision for quality review (e.g., by flagging the respective investigator decision for quality review if the investigator decision and the prediction do not match).

In accordance with the present disclosure, the AI model framework that is utilized to predict whether transaction activity underlying an investigator decision is suspicious may include at least a “primary” evaluation path that comprises (i) a first AI model that is configured to generate and output a first prediction of whether the transaction activity underlying the investigator decision is suspicious based on an evaluation of structured feature data comprising values for a first set of structured feature variables that provide information about the account holder involved in the transaction as well as the investigator decision, (ii) a second AI model that is configured to generate and output a second prediction of whether the transaction activity underlying the investigator decision is suspicious based on an evaluation of unstructured feature data comprising textual data generated in connection with the investigator decision, and (iii) a prediction-combination component that functions to combine the first and second predictions into a single, combined prediction of whether the transaction activity underlying the investigator decision is suspicious—which may then be compared against the investigator decision so as to determine whether or not to flag the investigator decision for quality review.

Further, in accordance with the present disclosure, the AI model framework may additionally include a “secondary” evaluation path for investigator decisions that are not flagged for quality review by the primary evaluation path (i.e., investigator decisions that match the combined prediction output by the prediction-combination component), where that secondary evaluation path comprises (i) a third AI model that is configured to generate and output a third prediction of whether the transaction activity underlying the investigator decision is suspicious based on an evaluation of structured feature data comprising values for a second set of structured feature variables that provide information about the account holder involved in the transaction (but not any information about the investigator decision) and (ii) a prediction validation component that functions to compare the combined prediction from the primary evaluation path (which matched with the investigator decision) with the third prediction output by the third AI model and then flag the investigator decision for quality review if there is a mismatch between the combined prediction from the primary evaluation path and the third prediction (e.g., if the combined prediction is that the transaction activity is not suspicious but the third prediction is that the transaction activity is suspicious). In practice, the AI model framework may only use the secondary evaluation path in scenarios where both the combined prediction and the investigator decision indicate that the transaction activity underlying the investigator decision is not suspicious, but it is also possible that the AI model framework could use the secondary evaluation path in other scenarios.

Further yet, in accordance with the present disclosure, the AI model framework may additionally include an explainability component that functions to generate explanations for the predictions output by one or more of the AI models included within the AI model framework, which can then be presented to quality-review analysts alongside the flagged investigator decisions.

The AI model framework that is utilized to predict whether transaction activity underlying an investigator decision is suspicious may take other forms as well.

Further, as described in further detail below, the disclosed software-based pipeline may also carry out other functionality related to the evaluation of the investigator decisions.

In this way, the disclosed software technology applies a data-driven approach to identify investigator decisions for quality review that are more likely to have errors, thereby providing a number of advantages over existing technology for reviewing and validating investigator decisions for correctness, consistency, and/or completeness.

For instance, the disclosed software technology utilizes a new AI model framework to evaluate and identify investigator decisions for quality review, which involves multiple different AI models that generate and output predictions about whether certain transaction activity is suspicious based on different sets of feature data. For instance, as described below, the new AI model framework utilizes a first AI model that relies on feature data comprising a mix of structured account-holder data and structured investigator-decision data, a second AI model that relies on unstructured investigator-decision data, and a third AI model that relies on structured account-holder data (but not investigator-decision data). This disclosed AI model framework provides a more accurate identification of investigator decisions that are likely to be erroneous and should be presented for quality review than any of the existing technology for identifying investigator decision to present for quality review. And in turn, this allows quality-review analysts to focus their efforts on reviewing investigator decisions that are more likely to have errors. In fact, the disclosed technology may serve to significantly increase the extent of erroneous investigator decisions being reviewed while at the same time decreasing the overall number of investigator decisions that need to be reviewed, because the disclosed software technology will significantly reduce the extent of compliant investigator decisions that have to be reviewed by quality-review analysts.

Additionally, in at least some implementations, the disclosed software technology may utilize model explanability techniques to generate explanations for the predictions made by the AI model framework, which can elucidate why different investigator decisions were flagged for quality-review and thereby improve the quality-review process. For instance, the disclosed software technology may utilize model explanability techniques to determine which features were most influential to the predictions made by the AI model framework and may then present those features to the quality-review analysts along with the flagged investigator decisions, which may help the quality-review analysts during their quality review by providing guidance on what to focus on when reviewing the flagged investigator decisions. For instance, if a given feature is identified as being highly influential to the prediction made by the AI model framework and the investigator notes do not reflect that the investigator took that feature into account, that may provide support for a conclusion that the investigator decision was non-compliant. On the other hand, if a given feature is identified as being highly influential to the prediction made by the AI model framework but the investigator notes reflect that the investigator did take that feature into account, that may provide support for a conclusion that the investigator decision was actually compliant.

The disclosed software technology also provides other advantages over the existing technology which are apparent from the detailed discussion of the software technology that follows.

In practice, the disclosed software technology may be incorporated into a software application that is hosted on a back-end computing platform and is accessible by client devices over a communication path that typically includes the Internet (among other data networks that may be included). In this respect, the disclosed software technology may comprise server-side software installed on the back-end computing platform as well as client-side software that runs on the client devices and interacts with the server-side software, which could take the form of a client application running in a web browser (sometimes referred to as a “web application”), a native desktop application, or a mobile application, among other possibilities. However, the software technology could take other forms and/or be implemented in other manners as well.

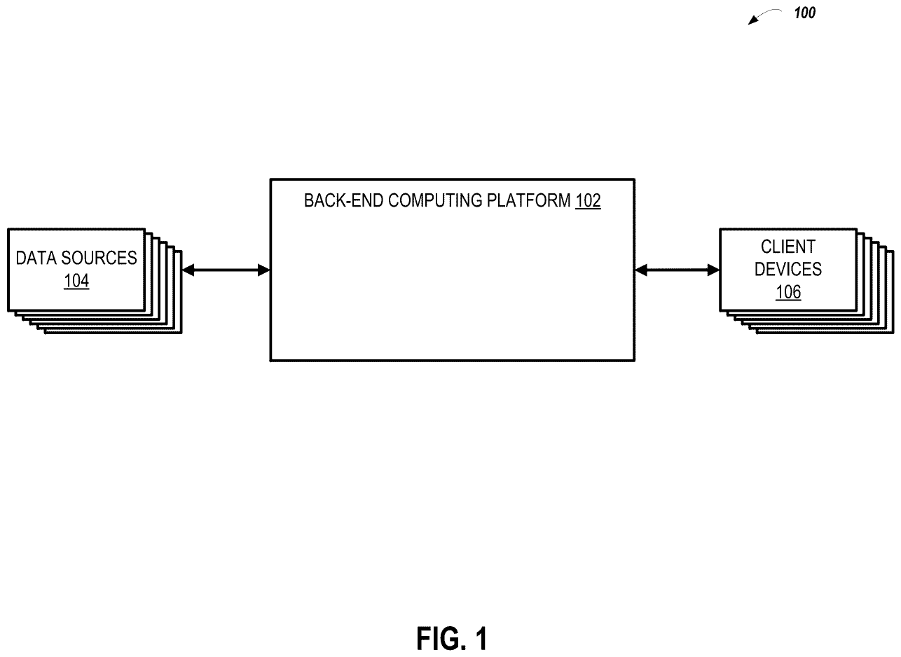

Turning now to the figures, FIG. 1 depicts one illustrative example of a computing environment 100 in which the disclosed software technology may be implemented. As shown, the example computing environment 100 may include a back-end computing platform 102 operated on behalf of an entity that is interested in monitoring financial transaction activity for suspicious activity (e.g., a financial institution that maintains financial accounts for account holders), a plurality of data sources 104, and a plurality of client devices 106, among other possibilities.

The back-end computing platform 102 may comprise any one or more computer systems (e.g., one or more servers) that have been installed with software for carrying out the back-end functionality disclosed herein. In practice, the one or more computer systems of the back-end computing platform 102 may collectively comprise some set of physical computing resources (e.g., one or more processors, data storage system, communication interfaces, etc.), which may take any of various forms. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of the given provider (e.g., servers owned by the given provider). As yet another possibility, the back-end computing platform 102 may comprise a combination of cloud computing resources and on-premises computing resources. Other implementations of the back-end computing platform 102 are possible as well.

Further, in practice, the software for carrying out the back-end functionality disclosed herein may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the software for carrying out the back-end functionality disclosed herein may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities. Such a data storage layer of the back-end computing platform 102 may contain any of various types of data, including but not limited to any of the various types of data involved in carrying out the back-end functionality disclosed here.

As shown, the back-end computing platform 102 may be communicatively coupled to a plurality of data sources 104 over respective communication paths. In general, each of these data sources 104 may comprise a computing system that is configured to provide the back-end platform 102 with data related to the back-end functionality disclosed herein, such as evaluating investigator decisions to determine whether or not to flag the investigator decisions for quality review and then causing the flagged investigator decisions to be presented to quality-review analysts.

As further shown, the back-end computing platform 102 may be communicatively coupled to a plurality of client devices 106 over respective communication paths. In general, each of these client devices 106 may comprise any computing device that enables a user to access and interact with the back-end computer platform 102 in order to carry out tasks related to the disclosed back-end functionality, such as configuration of the back-end functionality and/or evaluation of output provided by back-end computing platform 102. In this respect, each client device 106 may include hardware components such as one or more processors, computer-readable mediums, communication interfaces, and input/output (I/O) components (or interfaces for connecting thereto), among other possible hardware components, as well as software that enables a user to access and interact with the back-end computing platform 102 in order to carry out tasks related to the disclosed back-end functionality (e.g., operating system software, web browser software, a mobile application, etc.). As representative examples, each of example client devices 106 may take the form of a desktop computer, a laptop, a netbook, a tablet, a smartphone, or a personal digital assistant (PDA), among other possibilities.

In practice, the respective communication path between the back-end computing platform 102 and each data source 104 or client device 106 may generally comprise one or more data networks and/or data links, which may take any of various forms. For instance, the respective communication path between the back-end computing platform 102 and a given data source 104 or client device 106 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between the back-end computing platform 102 and a given data source 104 or client device 106 could be carried out via an Application Programming Interface (API), among other possibilities. Additionally, although not shown, the respective communication path between the back-end computing platform 102 and a given data source 104 or client device 106 could also include one or more intermediate systems, examples of which may include a data aggregation system or a host server, among other possibilities. Many other configurations are also possible.

It should be understood that the computing environment 100 is one example of a computing environment in which the disclosed software technology may be implemented, and that numerous other examples of computing environments are possible as well. For instance, in some implementations, the back-end computing platform 102 may additionally have a communication path with a third-party computing platform that is provided with access to data generated by the back-end computing platform 102 in accordance with the disclosed back-end functionality via an API or the like.

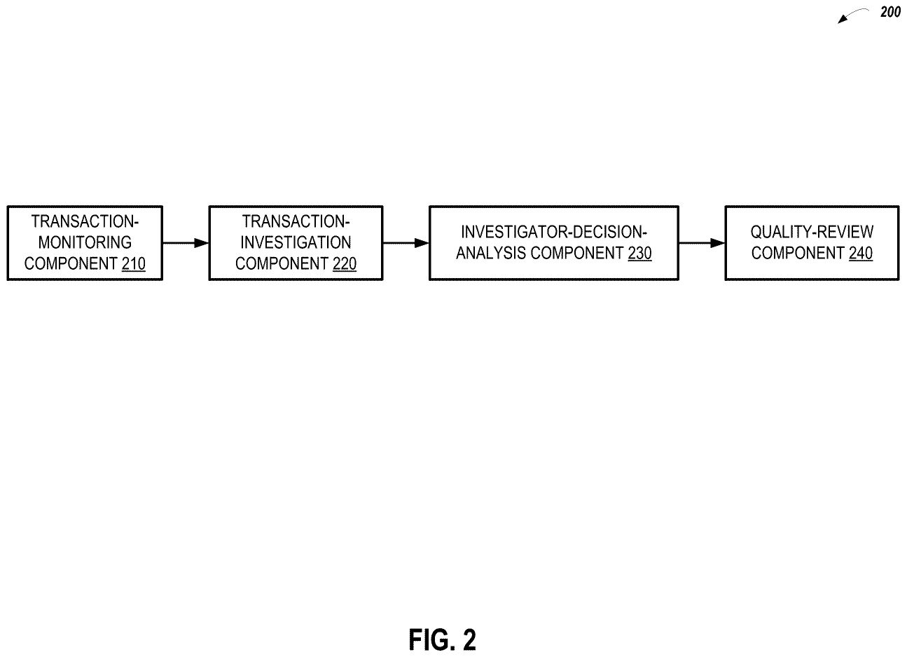

Turning now to FIG. 2, a block diagram is of an example software-based pipeline 200 that carries out functionality for performing quality-review analysis of investigator decisions is shown. In practice, the example software-based pipeline 200 may comprise a set of functional components, each of which may be encoded in the form of program instructions that are executable by one or more processors of one or more computing platforms. For purposes of illustration, the example software-based pipeline 200 is described as being installed on and executed by the back-end computing platform 102 of FIG. 1, but it should be understood that the example software-based pipeline 200 may be installed on and executed by any one or more computing platforms that are capable of performing the example operations of the example software-based pipeline 200, and in some cases, different components of the example software-based pipeline 200 may be executed by different computing platforms that communicate with one another via network-based communication paths. Further, it should be understood that the example software-based pipeline 200 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

As shown, the example software-based pipeline 200 may comprise a transaction-monitoring component 210, a transaction-investigation component 220, an investigator-decision-analysis component 230, and a quality-review component 240, each of which will be described in further detail below. Other implementations of the example software-based pipeline 200 are also possible.

As shown in FIG. 2, the example software-based pipeline 200 may begin with the transaction-monitoring component 210, which functions to (i) monitor transactions for potential suspicious activity and (ii) based on the monitoring, identify transaction activity that appears to be suspicious in nature and generate alerts for such transaction activity, which could be based on a single transaction or a set of multiple transactions. This functionality may take any of various forms.

In one implementation, the function of monitoring transactions for potential suspicious activity may involve evaluating data that is indicative of whether or not given transaction activity is suspicious using a data science model. In this respect, the evaluated data that is indicative of whether or not the given transaction activity is suspicious may take any of various forms.

For instance, as one possibility, the evaluated data that is indicative of whether or not the given transaction activity is suspicious may include data related to a given transaction or a set of multiple given transactions (e.g., transactions involving a same account holder), which may be referred to herein as “transaction data.” Such transaction data may take any of various forms.

As one illustrative example, the evaluated transaction data for a given transaction may include transaction-identification data, such as a respective transaction identifier (TX ID) (e.g., a Unique Transaction Identifier (UTI), a reference number, etc.) for the given transaction, among other possible types of transaction-identification data.

As another illustrative example, the evaluated transaction data for a given transaction may include monetary data, such as an indication of an amount paid in the given transaction and/or an indication of a type of currency used in the transaction, among other possible types of monetary data.

As yet another illustrative example, the evaluated transaction data for a given transaction may include goods/services data, such as an indication of types and/or quantities of products and/or services purchased via the given transaction, among other possible types of goods/services data.

As yet another illustrative example, the evaluated transaction data for a given transaction may include transaction-type data, such as an indication of a payment instrument used (e.g., credit, debit, check, cash, etc.), an indication of a payment gateway used (e.g., PayPal, Square, etc.), and/or an indication of whether the instrument used in the transaction was physically presented during the given transaction (e.g., whether the given transaction was a Card-not-present (CNP) or a Card-Present (CP), whether an electronic check or a physical check was used, etc.), among other possible types of transaction-type data.

As yet another illustrative example, the evaluated transaction data for a given transaction may include merchant data, such as an identification of a merchant involved in the given transaction (e.g., a merchant name or ID), an indication of a merchant category associated with the merchant (e.g., a Merchant Category code (MCC), a Standard Industrial Classification (SIC) code, a North American Industry Classification System (NAICS) code, etc.), a merchant risk score associated with the merchant, location data associated with the merchant (e.g., an address of the merchant, a country of origin of the merchant, etc.), network data associated with the merchant (e.g., a domain name, a Uniform Resource Locator (URL), an Internet Protocol (IP) address, etc.), and/or fraud reports associated with the merchant (e.g., reports found in the Federal Trade Commission's (FTC's) Consumer Sentinel Network database), among other possible types of merchant data.

As yet another illustrative example, the evaluated transaction data for a given transaction may include device data associated with a device used in the given transaction, such as an indication of a device type (e.g., a mobile device, a computer such as a desktop or laptop, a point-of-sale (POS) terminal, a Personal Identification Number (PIN) pad, a card reader, etc.), a device identifier (e.g., a unique device identifier (UDI), an International Mobile Equipment Identity (IMEI), a Mobile Equipment Identifier (MEID), an Electronic Serial Number (ESN), etc.), an indication of a device location at the time when the given transaction took place (e.g., Global Positioning System (GPS) coordinates, etc.), and/or network data associated with the device (e.g., an IP address, a Media Access Control (MAC) address, etc.), among other possible types of device data.

As yet another illustrative example, the evaluated transaction data for a given transaction may include authentication data associated with the given transaction. Such authentication data may indicate an authentication method used during the given transaction, such as two-factor authentication, password authentication, biometric authentication, Card Verification Value (CVV) authentication, Address Verification System (AVS) authentication, Challenge Handshake Authentication Protocol (CHAP) authentication, and/or 3D Secure authentication (e.g., 3D Secure 2 (3DS2 ), etc.), among other possible types of authentication data.

As yet another illustrative example, the evaluated transaction data for a given transaction may include timing data, such as an indication of a time at which the given transaction was initiated (e.g., a timestamp indicating an hour of the day and/or a date), an indication of a time of day at which the given transaction was completed (e.g., a timestamp indicating an hour of the day and/or a date), an indication of an amount of time taken to complete the given transaction, and/or an indication of an time taken for the given transaction to clear, among other possible examples of timing data.

As yet another example, the evaluated transaction data for a given transaction may include shipping data, such as a shipping address for the given transaction, an identification of a shipping carrier (e.g., United Postal Service (UPS), Federal Express (FedEx), etc.), an indication of a shipping method (e.g., overnight, expedited, flat-rate, etc.), and/or an indication of a shipping cost, among other possible examples of shipping data.

The transaction data that may be evaluated by the transaction-monitoring component 210 when evaluating given transaction activity for potential suspicious activity may also take other forms, including but not limited to the possibility that the transaction data may comprise an aggregation of certain types of transaction data across multiple individual transactions.

As another possibility, the evaluated data that is indicative of whether or not the given transaction activity is suspicious may include data related to an account holder (e.g., an entity such as a person or a business) of a financial account involved in the given transaction activity, which may be referred to herein as “account-holder data.” Such account-holder data may take any of various forms.

As one illustrative example, the evaluated account-holder data for the given transaction activity may include account-identification data such as a name of the account holder, a Legal Entity Identifier (LEI) for the account holder (e.g., if the account holder is a business), an account number (e.g., a credit card number, a checking account number, etc.) for the account associated with the given payment, an instrument number (e.g., a check number, etc.), and/or a routing number for a financial institution (e.g., a bank, a credit union, etc.) in which the account is held, among other possible types of account-identification data.

As yet another illustrative example, the evaluated account-holder data for the given transaction activity may include account-location data associated with the account, such as a business address, a home address, and/or an address of a home branch of the financial institution associated with the account, among other possible types of account-location data.

As yet another example, the evaluated account-holder data for the given transaction activity may include account-description data, such as an indication of an account type (e.g., credit, checking, savings, etc.) for the account, a balance (e.g., a ledger balance, an available balance, a credit balance, etc.), and/or an indication of one or more account restrictions (e.g., a credit limit, a daily Automated Teller Machine (ATM) withdrawal limit, a daily debit purchase limit, a transaction limit, a daily Peer-to-Peer (P2P) payment limit, etc.), among other possible types of account-description data.

As yet another illustrative example, the evaluated account-holder data for the given transaction activity may include demographic data associated with the account holder (e.g., if the account holder is a person), such as an age of the account holder and/or an income amount (e.g., a gross annual income) associated with the account holder, among other possible types of demographic data. In this respect, it should be understood that the use and/or storage of such demographic data may be regulated by laws of one or more jurisdictions (e.g., a jurisdiction in which a party to the given transaction resides, a jurisdiction in which a party to the transaction is a citizen, a jurisdiction in which a party to the given transaction is incorporated, a jurisdiction where the given transaction takes place, etc.), and whether or not the evaluated account-holder data for the given transaction may include demographic data of certain types may be dictated by such laws.

As yet another illustrative example, the evaluated account-holder data for the given transaction activity may include business-description data (e.g., if the account holder is a business), such as balance-sheet data (e.g., gross profit, net profit, etc.) for the account holder, an indication of a business type (e.g., corporation, limited liability company (LLC), partnership, non-profit, sole proprietorship, etc.) for the account holder, and/or an indication of an industry classification (e.g., manufacturing, service, agriculture, etc.) for the account holder, among other possible types of business-description data for the account holder.

As yet another illustrative example, the evaluated account-holder data for the given transaction activity may include historical data about the account, such as historical transaction data for previous transactions made using the account (e.g., the types of transaction data described above) and/or historical data regarding notable incidents that have occurred on the account (e.g., data indicating whether any previous transactions made using the account have been flagged as suspicious, whether the payment instrument has been reported as lost or stolen, whether information associated with the account has been compromised in a data breach, etc.), among other possible types of historical data.

As yet another illustrative example, the evaluated account-holder data for the given transaction activity may include adverse-media data regarding the account holder, such as a news website, a news broadcast, a blog, an online review, a social media posting, and/or some other type of medium, among other possible types of adverse-media data.

As yet another illustrative example, the evaluated account-holder data for the given transaction activity may include an indicator of whether the account holder is a politically exposed person (PEP).

The account-holder data that may be evaluated by the transaction-monitoring component 210 when evaluating given transaction activity for potential suspicious activity may also take other forms.

As yet another possibility, the evaluated data that is indicative of whether or not the given transaction activity is suspicious may include data about other parties involved in the given transaction activity, such as data about a merchant involved in a given transaction. Examples of such merchant data could be similar to the examples of the account-holder data described above (e.g., identifying data, adverse-media data, a PEP indicator, etc.).

As still another possibility, the evaluated data that is indicative of whether or not the given transaction activity is suspicious may include jurisdictional data, such as a jurisdiction in which a party involved in the given transaction activity resides, a jurisdiction in which a party involved in the given transaction activity is incorporated, and/or a jurisdiction where a given transaction takes place, among other possible types of jurisdictional data. The jurisdictional data that may be evaluated by the transaction-monitoring component 210 when evaluating a given transaction for potential suspicious activity may also take other forms.

Other types of data that are indicative of whether or not given transaction activity is suspicious may be evaluated by the transaction-monitoring component 210 as well.

Further, the data science model that the transaction-monitoring component 210 utilizes to evaluate the data that is indicative of whether or not given transaction activity is suspicious may take any of various forms. For instance, as one possibility, the data science model may be a rules-based model that encodes a set of rules for evaluating data related to given transaction activity to predict whether or not the given transaction activity appears to be suspicious. As another possibility, the data science model may be an AI model that is trained using a machine-learning process (e.g., a process involving a supervised, unsupervised, and/or semi-supervised learning technique) and is configured to (i) receive feature data related to given transaction activity and (ii) based on an evaluation of the feature data, generate and output a prediction of whether the given transaction activity appears to be suspicious. The data science model may take other forms as well.

In other implementations, the function of monitoring transactions for potential suspicious activity may take other forms as well, including, but not limited to, the possibility that the transactions are monitored for potential suspicious activity in a manner that does not involve the use of a data science model.

As discussed above, based on the monitoring of transactions for potential suspicious activity, the transaction-monitoring component 210 may identify certain transaction activity that appears to be suspicious and then generate alerts for such transaction activity. These alerts may take any of various forms.

For instance, as one possibility, an alert that is generated by the transaction-monitoring component 210 for given transaction activity may comprise an identification of one or more transactions involved in the given transaction activity along with other transaction data and/or account-holder data associated with the given transaction activity that may subsequently be utilized by an investigator to determine whether or not the given transaction activity does in fact appear to be suspicious such that it should be reported to the appropriate authorities, among other possible types of data that may be included or otherwise associated with an alert generated by the transaction-monitoring component 210.

The alerts that are generated by the transaction-monitoring component 210 may also take other forms.

The transaction-monitoring component 210 may further function to (i) store the generated alerts (e.g., in a data storage layer of the back-end computing platform 102) for future access and use by other components of the example software-based pipeline 200 (e.g., as described below) and/or (ii) send the generated alerts to other components of the example software-based pipeline 200. (In line with the discussion above, it is also possible that the transaction-monitoring component 210 could be implemented on a separate computing platform from the back-end computing platform 102, in which case the alerts may be accessed from that other computing platform).

The transaction-investigation component 220 may generally function to (i) receive alerts for transaction activity that has been identified by the transaction-monitoring component 210 as appearing to be suspicious, (ii) present identified transaction activity to investigators that are tasked with reviewing such transaction activity via a graphical user interface (GUI) referred to herein as an “transactions review GUI,” and (iii) receive investigator input regarding the transaction activity via the transactions review GUI. This functionality may take various forms.

To begin, the transaction-investigation component 220 may receive alerts for identified transaction activity by loading alerts from a data storage layer of the back-end computing platform 102, receiving alerts from the transaction-monitoring component 210, and/or obtaining alerts from some other source. In turn, the transaction-investigation component 220 may (i) receive a request from a given investigator to access the transactions review GUI, which may be embodied in the form of one or more messages that are sent by a client device associated with the given investigator over a network-based communication path to the back-end computing platform 102, and (ii) in response to receiving the request, cause the transactions review GUI to be presented to given investigator, which may involve the back-end computing platform 102 sending one or more messages over the network-based communication path that instruct and cause the client device to render the transactions review GUI.

After being presented with the transactions review GUI, the given investigator may begin to review certain of the transaction activity that has been identified by the transaction-investigation component 220 as appearing to be suspicious via the given investigator's client device. For instance, the given investigator may utilize the client device to select certain transaction activity within the transactions review GUI, which may cause the transactions review GUI to present the given investigator with details regarding the selected transaction activity. Additionally, the given investigator may utilize the client device to access other information that may be helpful in reviewing the selected transaction activity (e.g., by accessing other software applications on the client device).

After the given investigator has completed his or her review of the selected transaction activity, the given investigator may reach a decision as to whether or not the given investigator believes that the selected transaction activity was suspicious, which may be referred to herein as an “investigator decision,” and may then use the client device to input, into the transactions review GUI, (i) an indication of the investigator decision for the selected transaction activity along with (ii) other associated investigator-decision data (e.g., natural-language and/or free-form notes that indicate reasoning and/or facts on which the investigator decision is based).

In practice, the client device of the given investigator may then send the given investigator's input to the back-end computing platform 102 over the network-based communication path, and the transaction-investigation component 220 may thereafter receive the given investigator's input comprising the indication of the investigator decision and the associated investigator-decision data (e.g., notes) for the selected transaction.

The foregoing process may be repeated for any of various transaction activity that may be accessed and reviewed by any of various investigators.

The transaction-investigation component 220 may further function to (i) store the received indications of the investigator decisions and associated investigator-decision data (e.g., in a data storage layer of the back-end computing platform 102) for future access and use by other components of the example software-based pipeline 200 (e.g., as described below) and/or (ii) send the received indications of the investigator decisions and associated investigator-decision data to other components of the example software-based pipeline 200. (In line with the discussion above, it is also possible that the transaction-investigation component 220 could be implemented on a separate computing platform from the back-end computing platform 102, in which case the indications of the investigator decisions and associated investigator-decision data may be accessed from that other computing platform.)

The investigator-decision-analysis component 230 may generally function to receive indications of investigator decisions (along with associated investigator-decision data) that were input into the transaction-investigation component 220 and then utilize an AI model framework to evaluate each such investigator decision for purposes of determining whether or not to flag the investigator decision for quality review. This functionality may take any of various forms.

To begin, the functionality for receiving indications of investigator decisions (along with associated investigator-decision data) may involve loading such data from a data storage layer of the back-end computing platform 102, receiving such from the transaction-investigation component 220, and/or obtaining such data from some other source, among other possibilities.

Further, in at least one implementation, the functionality of utilizing an AI model framework to evaluate a given investigator decision for purposes of determining whether or not to flag the given investigator decision for quality review may involve (i) loading source data for use in predicting whether the transaction activity underlying the given investigator decision is suspicious, (ii) based on the loaded source data, prepare feature data for an AI model framework that is configured to predict whether the transaction activity underlying the given investigator decision is suspicious, (iii) inputting the feature data into the AI model framework and thereby causing the AI model framework to generate and output a prediction of whether the transaction activity underlying the given investigator decision is suspicious, and (iv) based on the prediction, determine whether to flag the given investigator decision for quality review (e.g., by flagging the investigator decision for quality review if the given investigator decision and the prediction do not match).

In this implementation, the source data that is loaded by the investigator-decision-analysis component 230 for the transaction activity underlying the given investigator decision may take any of various forms.

For instance, as one possibility, the source data that is loaded by the investigator-decision-analysis component 230 may include structured source data (sometimes referred to as “tabular” source data), which may generally take the form of values for some set of defined numerical and/or categorical variables that may be utilized as a basis for predicting whether the transaction activity underlying the given investigator decision is suspicious. Some illustrative examples of types of structured source data that may be loaded by the investigator-decision-analysis component 230 for the transaction activity underlying the given investigator decision may include transaction data for the transaction activity underlying the given investigator decision (e.g., monetary data, goods/services data, transaction-type data, merchant data, device data associated with a device used in the transaction, authentication data, timing data, and/or shipping data), account-holder data for the transaction activity underlying the given investigator decision (e.g., account-location data, account-description data, demographic data, business-description data, historical data), jurisdictional data for the transaction activity underlying the given investigator decision, adverse-media data for the transaction activity underlying the given investigator decision, a PEP indicator for a party involved in the transaction activity underlying the given investigator decision, and/or structured data fields included within the investigation-decision data for the transaction, among other possible types of structured source data that may be loaded for the transaction activity underlying the given investigator decision.

As another possibility, the source data that is loaded by the investigator-decision-analysis component 230 may include unstructured source data (sometimes referred to as “raw” source data), which may generally comprise data that does not take the form of values for defined numerical and/or categorical variables but may nevertheless be utilized as a basis for predicting whether the transaction activity underlying the given investigator decision is suspicious, such as textual data, audio data, and/or image data. Some illustrative examples of types of unstructured source data that may be loaded by the investigator-decision-analysis component 230 for the transaction activity underlying the given investigator decision may include textual data, audio data, and/or image data that was included as part of the investigator-decision data input by the investigator in association with the given investigator decision, such as investigator notes that indicate reasoning and/or facts on which the investigator decision is based, audio recordings of meetings in which the investigator decision was discussed, and/or scanned images of notes, among various other possibilities.

The investigator-decision-analysis component 230 may load other types of source data for the given investigator decision as well.

Based on the foregoing, it will be appreciated that the source data loaded by the investigator-decision-analysis component 230 may overlap with the data that is utilized by the transaction-monitoring component 210 to determine whether transaction activity appears to be suspicious, but unlike the data evaluated by the transaction-monitoring component 210, the source data loaded by the investigator-decision-analysis component 230 will typically include investigator-decision data (which is unavailable to the transaction-monitoring component 210). The source data that is loaded by the investigator-decision-analysis component 230 may differ from the data that is utilized by the transaction-monitoring component 210 in other ways as well.

Further, in this implementation, the feature data for the AI model framework that is prepared by the investigator-decision-analysis component 230 for the transaction activity underlying the given investigator decision may take any of various forms.

For instance, as one possibility, the feature data that is prepared by the investigator-decision-analysis component 230 for the transaction activity underlying the given investigator decision may include structured feature data (sometimes referred to as “tabular” feature data), which may generally take the form of values for some set of defined numerical and/or categorical feature variables that may be provided as input to an AI model that is configured to predict whether the transaction activity underlying the given investigator decision is suspicious. In general, such feature variables (which may be referred to herein as “structured feature variables”) may be extracted from the transaction data, account-holder data, and/or investigator-decision data that is loaded as source data, and these structured featured variables may take any of various forms.

As one example, the structured feature variables may include one or more feature variables that are based on account-holder attributes and/or characteristics, which may be referred to herein as “account-holder-attribute feature variables.” Account-holder-attribute feature variables may include demographic feature variables (e.g., the age of an account holder, the annual income of the account holder, etc.) and/or creditworthiness feature variables (e.g., a credit score of the account holder, a debt-to-income ratio of the account holder, a length of an account holder's credit history, etc.), among other possible types of account-holder-attribute feature variables.

As another example, the structured feature variables may include one or more feature variables that are based on transaction activity by the account holder (e.g., on one or more accounts held by the account holder) within a given window of time (e.g., the past day, the past week, etc.), which may be referred to herein as “transaction-activity feature variables.” Transaction-activity feature variables may indicate, for example, amount paid in transactions from a given window of time, products and/or services purchased in transactions from a given window of time, types of payment instruments used in transactions from a given window of time, types of transactions that have occurred in connection with one or more accounts held by the account holder from a given window of time, classifications associated with parties to transactions from a given window of time (e.g., an MCCs, NAICS codes, SIC codes, etc.), and/or credit metrics (e.g., credit limit, a credit utilization ratio, a credit utilization percentage, etc.) for the one or more accounts, among other possible types of transaction-activity feature variables.

As yet another example, the structured feature variables may include one or more feature variables that are based on other kinds of account activity for the account holder within a recent window of time (e.g., the past day, the past week, etc.), which may be referred to herein as “account-activity feature variables.” Account-activity feature variables may indicate account activities other than transactions, such as changes of one or more types made to the one or more accounts (e.g., changes to contact information, requests to increase credit limits, additions of shipping addresses, etc.), among other possible types of account-activity feature variables.

As still another example, the structured feature variables may include one or more feature variables that are based on investigator-decision data, which may be referred to herein as “investigator-decision feature variables.” Investigator-decision feature variables may provide certain data about the investigator decision in structured form, such as data about the presence and/or frequency of certain types of words within the investigator notes (e.g., a value of one for a feature variable corresponding to a particular word is present in the investigator decision and a value of zero if the particular word is not present in the investigator decision), among other possible types of investigator-decision feature variables feature variables.

Further, in practice, the structured feature variables could include (i) feature variables having values that are based on structured source data (e.g., structured features extracted from numerical or categorical source variables), (ii) feature variables having values that are based on unstructured source data (e.g., structured features extracted from source text, audio, or images), or (iii) a combination thereof.

Further yet, in practice, at least some of the structured feature variables may already be present in the source data that is loaded by the investigator-decision-analysis component 230, in which case these feature variables may be extracted from the source data without any further transformation.

As another possibility, the feature data that is prepared by the investigator-decision-analysis component 230 for the transaction activity underlying the given investigator decision may include unstructured feature data (sometimes referred to as “raw” feature data), which may generally comprise data that does not take the form of values for defined numerical and/or categorical variables but may nevertheless be provided as input to an AI model that is configured to predict whether the transaction activity underlying the given investigator decision is suspicious, such as textual data, audio data, and/or image data. Some illustrative examples of types of unstructured feature data that may be prepared by the investigator-decision-analysis component 230 for the transaction activity underlying the given investigator decision may include textual data that is included as part of the investigator-decision data (e.g., natural-language and/or free-form notes written by an investigator that indicate reasoning and/or facts on which the investigator considered when rendering the given investigator decision) and perhaps also audio and/or image data included as part of the investigator-decision data.

The investigator-decision-analysis component 230 may prepare other types of feature data for the transaction activity underlying given investigator decision as well.

Further yet, the AI model framework that is utilized by the investigator-decision-analysis component 230 to generate the prediction of whether the transaction activity underlying the given investigator decision is suspicious may include one or more AI models that may each take any of various forms—including any of various forms of AI models that may be created utilizing a machine-learning process involving one or more machine learning techniques (e.g., supervised, semi-supervised, and/or unsupervised machine learning techniques). For example, the one or more AI models included in the disclosed AI model framework may comprise any one or more of a regression model, a decision-tree-based model (e.g., a gradient boosting model, random forest model, etc.), a support vector machine (SVM)-based model, a Bayesian model, a k-Nearest Neighbor (kNN) model, a Gaussian process model, a neural-network model (e.g., a feedforward, recurrent, or convolutional neural-network model, a deep learning model, a transformer-based model, a generative adversarial network (GAN) model, an autoencoder-based model, etc.), a clustering model, an association-rule model, a dimensionality-reduction model, and/or a reinforcement-learning model, among other possible examples of AI models that can be created using machine learning techniques. And depending on the form of the AI model, the input and output of the AI model may likewise take any of various forms.

For instance, as one possibility, the disclosed AI model framework may include one or more instances of a first type of AI model that is configured to (i) receive structured feature data for the transaction activity underlying the given investigator decision comprising values for a given set of feature variables and (ii) based on an evaluation of the structured feature data, generate and output a prediction of whether the transaction activity underlying the given investigator decision is suspicious. This first type of AI model may take any of various forms.

To begin, the structured feature data for the transaction activity underlying the given investigator decision that is received as input by the first type of AI model may include values for any of various types of feature variables that may be predictive of whether the transaction is suspicious, including, but not limited to, any of various types of feature variables described above.

Further, the prediction of whether the transaction activity underlying the given investigator decision is suspicious that is generated and output by the first type of AI model could take the form of (i) a numerical value that quantifies a likelihood that the transaction activity is suspicious, and/or (ii) a categorical value that indicates whether or not the transaction activity is suspicious, such as yes/no or 1/0 value, among various other possibilities.

Further yet, the first type of AI model may comprise any form of AI model that is capable of receiving structured feature data and then outputting a numerical or categorical output value, examples of which may include a regression model, a decision-tree-based model, an SVM-based model, a Bayesian model, a kNN model, a Gaussian process model, a neural-network model, and/or a clustering model, among other possibilities.

Still further, depending on the form of the first type of AI model, the process of creating the first type of AI model may take various forms. As one possible example, that process may involve (i) identifying previous instances of transaction activity to use as the basis for training the AI model, (ii) obtaining a training dataset for training the AI model, which may comprise (a) data records for previous instances of transaction activity that include values for the given set of feature variables (and perhaps other feature variables) along with (b) corresponding ground-truth values (sometimes referred to as “labels”) indicating whether the previous instances of transaction activity were found to be suspicious, and then (ii) applying a machine-learning process (e.g., a process involving supervised, semi-supervised, and/or unsupervised machine learning techniques) to the training data one or more times in order to train one or more instances of the AI model. Further, in scenarios where a single instance of the AI model is trained, the process of creating the AI model may additionally involve validating the performance of the AI model against some threshold level of performance utilizing a validation dataset (or sometimes referred to as a “test dataset”) that has a similar form to the generated training dataset. Alternatively, in scenarios where multiple instances of the AI model are trained (e.g., through the use of different sets of hyperparameters), the process of creating the AI model may additionally involve comparing the performance of the multiple instances of the AI model utilizing a validation dataset (or sometimes referred to as a “test dataset”) that has a similar form to the generated training dataset and then selecting the instance of the AI model having the best performance. The process of creating the first type of AI model may take various other forms as well—including, but not limited to, the possibility that the first type of AI model could be re-trained and/or refined (e.g., via reinforcement learning) based on additional data that may become available after training.

The first type of AI model may take various other forms as well.

As another possibility, the disclosed AI model framework may include one or more instances of a second type of AI model that is configured to (i) receive unstructured feature data for the transaction activity underlying the given investigator decision and (ii) based on an evaluation of the unstructured feature data, generate and output a prediction of whether the transaction activity underlying the given investigator decision is suspicious. This second type of AI model may take any of various forms.

To begin, the unstructured feature data for the respective transaction that is received as input by the second type of AI model may include any of various types of unstructured feature data, including but not limited to any of the various types of unstructured feature data described above (e.g., textual data such as notes associated with the investigator decision, audio data, image data, etc.).

Further, similar to the first type of AI model, the prediction of whether the transaction activity underlying the given investigator decision is suspicious that is generated and output by the second type of AI model could take the form of (i) a numerical value that quantifies a likelihood that the transaction activity is suspicious, and/or (ii) a categorical value that indicates whether or not the transaction activity is suspicious, such as yes/no or 1/0 value, among various other possibilities.

Further yet, the second type of AI model may comprise any form of AI model that is capable of receiving unstructured feature data (e.g., at least textual data) and then outputting a numerical or categorical output value, examples of which may include a deep learning model such as a feedforward, recurrent, and/or convolutional neural-network model, a transformer-based model (e.g., a model based on a Bidirectional Encoder Representations from Transformers (BERT) architecture such as a Robustly Optimized BERT Approach (RoBERTa) model), a GAN model, or an autoencoder-based model, among other possibilities.

Still further, depending on the form of the second type of AI model, the process of creating the second type of AI model may take various forms. As one possible example, that process may involve (i) identifying previous instances of transaction activity to use as the basis for training the AI model, (ii) obtaining a training dataset for training the AI model, which may comprise (a) unstructured feature data for the previous instances of transaction activity (e.g., textual notes for investigator decisions) along with (b) corresponding ground-truth values (sometimes referred to as “labels”) indicating whether the previous instances of transaction activity were found to be suspicious, and then (ii) applying a machine-learning process (e.g., a process involving supervised, semi-supervised, and/or unsupervised machine learning techniques) to the training data one or more times in order to train one or more instances of the AI model. Further, in scenarios where a single instance of the AI model is trained, the process of creating the AI model may additionally involve validating the performance of the AI model against some threshold level of performance utilizing a validation dataset (or sometimes referred to as a “test dataset”) that has a similar form to the generated training dataset. Alternatively, in scenarios where multiple instances of the AI model are trained (e.g., through the use of different sets of hyperparameters), the process of creating the AI model may additionally involve comparing the performance of the multiple instances of the AI model utilizing a validation dataset (or sometimes referred to as a “test dataset”) that has a similar form to the generated training dataset and then selecting the instance of the AI model having the best performance.

As another possible example, the process of creating the second type of AI model may involve (i) obtaining an instance of a pre-trained AI model (e.g., a pre-trained transformed-based model such as a BERT-based model), (ii) identifying previous instances of transaction activity to use as the basis for fine tuning the pre-trained AI model, (iii) obtaining a training dataset for fine tuning the pre-trained AI model, which may comprise (a) unstructured feature data for the previous instances of transaction activity (e.g., textual notes for investigator decisions) along with (b) corresponding ground-truth values (sometimes referred to as “labels”) indicating whether the previous instances of transaction activity were found to be suspicious, and then (iv) fine tuning the pre-trained AI model based on the training dataset (e.g., by applying one or more supervised fine-tuning techniques) one or more times in order to train one or more instances of the AI model via fine turning. Further, in scenarios where a single instance of the AI model is trained via fine tuning, the process of creating the AI model may additionally involve validating the performance of the AI model against some threshold level of performance utilizing a validation dataset (or sometimes referred to as a “test dataset”) that has a similar form to the generated training dataset. Alternatively, in scenarios where multiple instances of the AI model are trained via fine turning (e.g., through the use of different sets of hyperparameters), the process of creating the AI model may additionally involve comparing the performance of the multiple instances of the AI model utilizing a validation dataset (or sometimes referred to as a “test dataset”) that has a similar form to the generated training dataset and then selecting the instance of the AI model having the best performance.

The process of creating the second type of AI model may take various other forms as well—including, but not limited to, the possibility that the second type of AI model could be re-trained and/or refined (e.g., via reinforcement learning) based on additional data that may become available after training.

The second type of AI model may take various other forms as well.

The disclosed AI model framework may include other types of AI models that are utilized to evaluate whether the given investigator decision should be flagged for quality review as well.

Further, in practice, the disclosed AI model framework may be configured to predict whether the transaction activity underlying the given investigator decision is suspicious utilizing either (i) a single AI model, which could be of the first type or the second type, or (ii) multiple AI models that are of the same type and/or of different types. In this respect, the disclosed AI model framework may comprise any of various architectures of AI models and other functional components.

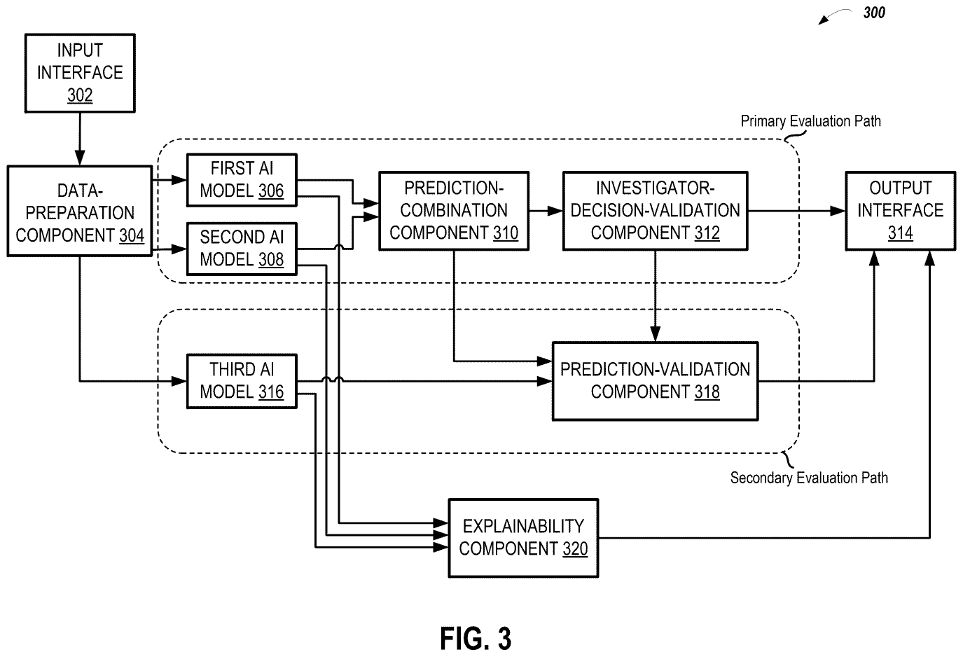

Turning now to FIG. 3, a block diagram is of an example architecture 300 of the investigator-decision-analysis component 230 is shown. In practice, the example architecture 300 may comprise a set of functional components, each of which may be encoded in the form of program instructions that are executable by one or more processors of a computing platform. It should be understood that the example architecture 300 of the investigator-decision-analysis component 230 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

As shown in FIG. 3, the example architecture 300 of the investigator-decision-analysis component 230 may include at least an input interface 302, a data-preparation component 304, a first AI model 306, a second AI model 308, a prediction-combination component 310, an investigator-decision-validation component 312, and an output interface 314. Further, as shown in FIG. 3, the example architecture 300 of the investigator-decision-analysis component 230 may additionally include a third AI model 316 and a prediction-validation component 318. In this respect, the first AI model 306, the second AI model 308, the prediction-combination component 310, and the investigator-decision-validation component 312 may define a first evaluation path between the input interface 302 and the output interface 314, which may be referred to herein as the “primary” evaluation path of the example architecture 300, and then the third AI model 316 and the prediction-validation component 318 may define a second evaluation path between the input interface 302 and the output interface 314, which may be referred to herein as the “secondary” evaluation path of the example architecture 300. Further yet, as shown in FIG. 3, the example architecture 300 of the investigator-decision-analysis component 230 may additionally include an explainability component 320 that may interface with various other components of the example architecture 300.

Each of the foregoing components of the example architecture 300 will now be described in further detail below. For purposes of illustration only, the functionality of the components is described with reference to a single investigator decision—namely, the given investigator decision introduced above—but it should be understood that, in practice, the described functionality may be carried out for each of many different investigator decisions.

To begin, the input interface 302 of the example architecture 300 may function to (i) load source data for use in predicting whether the transaction activity underlying the given investigator decision is suspicious and then (ii) pass the loaded source data to the data-preparation component 304.

The source data that is loaded by the input interface 302 may take any of various forms, including but not limited to any of the various forms described above. For instance, in line with the discussion above, the source data that is loaded by the input interface 302 may include both (i) structured source data that is to be used as a basis for producing structured feature data for the first AI model 306 and the third AI model 316 and (ii) unstructured source data that is be used as a basis for producing unstructured feature data for the second AI model 308.

Further, the function of loading the source data may take any of various forms. For instance, as one possibility, the function of loading the source data may involve retrieving at least a portion of the source data from a data storage layer of the back-end computing platform 102, which may contain source data that was previously received by the back-end computing platform 102 from another data source 104 and/or was previously generated by the back-end computing platform 102.

As another possibility, the function of loading the source data may involve obtaining at least a portion of the source data from one or more data sources 104, such as by causing the back-end computing platform 102 to send a request for source data to a given data source 104 via a network-based communication path (e.g., in the form of a HyperText Transfer Protocol (HTTP) request or the like) and then receive the source data back from the given data source 104 via the network-based communication path (e.g., in the form of an HTTP response or the like). In this respect, as noted above, the one or more data sources 104 may take any of various forms, one example of which may be a separate computing platform that generated certain of the source data (e.g., a separate computing platform running the transaction-monitoring component 210).

As yet another possibility, the function of loading the source data may involve retrieving a first portion of the source data from a data storage layer of the back-end computing platform 102 and obtaining a second portion of the source data from one or more data sources 104.

The function of loading the source data may take other forms as well.

As discussed above, the input interface 302 may be configured to pass the loaded source data to the data-preparation component 304, which may function to (i) use the loaded source data as a basis for preparing respective sets of feature data for the AI models 306, 308, and 316 and then (ii) pass the respective sets of feature data to the AI models 306, 308, and 316.

The function of preparing a set of feature data based on the source data may take various forms and may depend on the nature of the source data that is received from the input interface 302 as well as the respective set of feature data that is being prepared. For instance, as discussed above, the source data may comprise either or both of structured source data and/or unstructured source data, and the feature data may likewise comprise either or both of structured source data and/or unstructured source data. In this respect, the functions that are carried out by the data-preparation component 304 may vary depending on whether the source data and feature data is structured or unstructured.

As one possibility, the data-preparation component 304 may be configured to receive structured source data and then produce certain structured feature data based on that structured source data. The manner in which the data-preparation component 304 prepares the structured feature data based on the structured source data may involve pre-processing functions that may take various forms.

As one example, the pre-processing functions involved in producing structured feature data based on structured source data may involve mapping source data variables to feature data variables. For instance, in some cases, a given feature variable and a given source variable may both represent a same attribute, and the data-preparation component 304 may have access to a data model (e.g., a source-to-feature mapping) that indicates the relationship between the given source variable maps and the given feature variable. When the data-preparation component 304 identifies a value for the given source variable in the structured source data (e.g., as a result of parsing the structured source data), the data-preparation component 304 may utilize the data model to map the value for the given source variable to a value for the given feature variable.

In some cases, the structured source data may indicate a format for the given source variable. The manner in which the structured source data indicates this format may depend on the specific form of the structured source data. For instance, if the structured source data is stored as a spreadsheet, the format for the source variable may be specified by metadata for a column that corresponds to the given source variable. The manner in which the structured source data indicates the format for the given source variable may also take other forms (e.g., in accordance with the form of the structured source data and a schema therefore). Similarly, a format for the given feature variable may be indicated based on a form specified for the structured feature data.

If the format for the given source variable matches the format for the given feature variable, the data-preparation component 304 may utilize the value for the given source variable as the value for the given feature variable. Alternatively, if the format for the given source variable does not match the format for the given feature variable, the data-preparation component 304 may transform the value for the given source variable from its original format into the format of the given feature value, which may involve functions such as converting from one unit type to another (e.g., months to years, etc.), changing a number of decimal places (e.g., by rounding, truncating, etc.), converting from one variable type to another (e.g., numerical to categorical, etc.), changing a scale (e.g., converting from a linear scale to a logarithmic scale), and/or normalizing, among other possible types of transformation functions.

As another example, the pre-processing functions involved in producing structured feature data based on structured source data may involve deriving a feature value for a feature variable based on two or more source variables.

In this example, a given feature variable may be defined as a function of two or more source variables, the investigator-decision-analysis component 230 may have access to a data model that indicates the relationship between the given feature variable and the two or more source variables. When the data-preparation component 304 identifies values for the two or more source variables in the structured source data (e.g., as a result of parsing the structured source data), the investigator-decision-analysis component 230 may utilize the values for the two or more source values as actual parameters (i.e., arguments) for the function of the two or more source variables to compute a value for the given feature variable.

For instance, consider a scenario in which the given feature variable represents a difference between an amount paid in a given transaction and an amount of available credit for an account used in the given transaction. In this scenario, the function that defines the given feature variable may specify that the amount paid be subtracted from the amount of available credit and, to compute a value for the given feature variable for given transaction, the data-preparation component 304 may subtract the value for a source variable that represents the amount paid from the value for a source variable that represents the amount of available credit.

As another illustrative example, consider a scenario in which the given feature variable represents a distance between a home address of an account holder and a shipping address for a given transaction. In this scenario, the function that defines the given feature variable may specify that the value of the given feature variable is a distance (e.g., a road distance, a Euclidean distance, etc.) between the home address and the shipping address. To compute a value for the given feature variable for the given transaction, the data-preparation component 304 may send a request to a data source (e.g., one of the plurality of data sources 104 shown in FIG. 1) that stores mapping data (e.g., Google® Maps) via a network-based communication path. The request may indicate the home address and the shipping address and may request that a road distance between the home address and the shipping address be returned in response to the request. Alternatively, the data-preparation component 304 may load a map from a data source and compute the distance based on a scale of the map.

Other examples involving different numbers of source variables and different types of computations are also possible.

The pre-processing functions involved in producing structured feature data based on structured source data may also take other forms.

As another possibility, the data-preparation component 304 may be configured to receive unstructured source data and then produce structured feature data based on that unstructured source data. The pre-processing functions involved in performing this operation may take various forms, which may depend in part on the type of unstructured source data that is received from the input interface 302.

In a first scenario where the unstructured source data includes textual data, the data-preparation component 304 may apply a technique for transforming the textual data into structured feature data, which is sometimes referred to as “text vectorization.” Examples of such text vectorization techniques may include Bag of Words (BoW), Term Frequency Inverse Document Frequency (TF-IDF), Word2Vec, and/or One Hot encoding, among other possible vectorization techniques. In this scenario, the structured feature data that is produced by the data-preparation component 304 may comprise values for some set of defined numerical and/or categorical variables that indicate the presence and/or frequency of distinct textual segments (e.g., individual words or phrases) found within the textual data. Additionally, prior to performing text vectorization, the data-preparation component 304 may also apply one or more other pre-processing techniques in order to prepare the textual data for transformation into the structured feature data, examples of which may include data cleaning functions such as inserting a null value for missing values, converting letters to lower and/or upper case, removing masked words, removing punctuation, removing numbers, removing stop words, removing single-letter words, stemming, lemmatizing, among other possibilities.

In a second scenario where the unstructured source data includes audio data, the data-preparation component 304 may apply a technique for transforming the audio data into structured feature data. For instance, the data-preparation component 304 may first apply a speech-recognition technique to generate a textual transcription of the audio data and may then apply a text vectorization technique to the textual transcription. Alternatively, the data-preparation component 304 may apply an audio vectorization technique to the audio data, examples of which may include Wav2Vec 2.0 and the techniques employed by the Librosa library. In this scenario, the structured feature data that is produced by the data-preparation component 304 may comprise values for some set of defined numerical and/or categorical variables that represent one or both of (i) the text transcribed from the audio data or (ii) the characteristics of the audio data.

In a third scenario where the unstructured source data includes image data, the data-preparation component 304 may apply a technique for transforming the image data into structured feature data. For instance, the investigator-decision-analysis component 230 may first apply optical character recognition (OCR) to the image data in order to extract text from the image data and may then apply a vectorization technique to the extracted text. Alternatively, the data-preparation component 304 may apply a feature extraction technique to the image data. In this scenario, the structured feature data that is produced by the data-preparation component 304 may comprise values for some set of defined numerical and/or categorical variables that represent one or both of (i) the text found within the image data or (ii) the features extracted from the image data.

The pre-processing functions involved in producing structured feature data from unstructured source data may also take other forms.

As yet another possibility, the data-preparation component 304 may be configured to receive unstructured source data and then produce unstructured feature data based on that unstructured source data. The pre-processing functions involved in performing this operation may take various forms, examples of which may include data cleaning functions such as inserting a null value for missing values, converting letters to lower and/or upper case, removing masked words, removing punctuation, removing numbers, removing stop words, removing single-letter words, stemming, and/or lemmatizing, among other possibilities.

The pre-processing functions involved in producing unstructured feature data from unstructured source data may also take other forms.

As noted above, the data-preparation component 304 may carry out some or all of the foregoing operations in order to produce (i) a first set of feature data for input into the first AI model 306, which may then be passed to the first AI mode 306, (ii) a second set of feature data for input into the second AI model 308, which may then be passed to the second AI model 308, and (iii) a third set of feature data for input into the third AI model 316, which may then be passed to the third AI model 316.

As noted above, the primary evaluation path may begin with the first AI model 306, which may comprise an instance of the first type of AI model that is configured to (i) receive the first set of feature data for the transaction activity underlying the given investigator decision that takes the form of structured feature data and (ii) based on an evaluation of the first set of feature data, generate and output a first prediction of whether the transaction activity underlying the given investigator decision is suspicious.

The first set of feature data may include feature values for a first set of structured feature variables, which may take any of various forms. For instance, in one implementation, the first set of structured feature variables may include (i) one or more account-holder-attribute feature variables (e.g., an indication of a demographic characteristic of the account holder, an indication of an account holder's creditworthiness, etc.), (ii) one or more transaction-activity feature variables (e.g., indications of types of transactions that have occurred over specified periods of time in connection with one or more accounts held by the account holder, indications of classifications associated with parties to past transactions, indications of credit metrics for the one or more accounts, etc.), (iii) one or more account-activity feature variables (e.g., indications of changes to contact information, etc.), and (iv) one or more investigator-decision feature variables (e.g., variables indicating the presence and/or frequency of certain words within the investigator notes). The first set of structured feature variables may also take other forms.

Further, the first prediction that is output by the first AI model 306 may take various forms, and in one implementation, the first prediction may comprise a first numerical value that quantifies a first predicted likelihood that the transaction activity underlying the given investigator decision is suspicious.

The first AI model 306 may also take other forms as well.

The primary evaluation path may also begin with the second AI model 308, which may comprise an instance of the second type of AI model that is configured to (i) receive the second set of feature data for the transaction activity underlying the given investigator decision that takes the form of unstructured feature data and (ii) based on an evaluation of the second set of feature data, generate and output a second prediction of whether the transaction activity underlying the given investigator decision is suspicious.

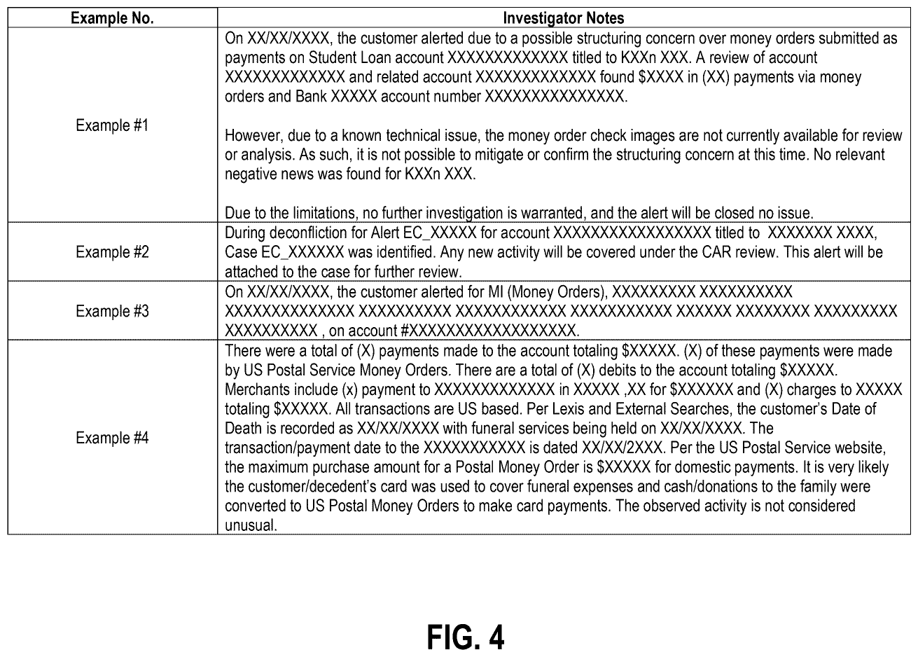

The second set of feature data may take various forms, and in one implementation, the second set of feature data may include a pre-processed version of the investigator notes for the given investigator decision. For purposes of illustration, some representative examples of pre-processed versions of investigator notes for investigator decisions are shown in FIG. 4.

Further, the second prediction that is output by the second AI model 308 may take various forms, and in one implementation, the second prediction may comprise a second numerical value that quantifies a second predicted likelihood that the transaction activity underlying the given investigator decision is suspicious.

The second AI model 308 may also take other forms, including but not limited to the possibility that in an alternative implementation, the second AI model 308 may be an instance of the first type of AI model that receives the second set of feature data in the form of structured feature data comprising values for structured feature variables that are based on and extracted from the investigator notes utilizing a text-vectorization technique.

The first and second predictions generated by the first and second AI models 306 and 308 may be passed to the prediction-combination component 310, which may generally function to (i) receive the first prediction that is output by the first AI model 306 and the second prediction that is output by the second AI model 308 and (ii) combine the first and second predictions into a combined prediction of whether the transaction activity underlying the given investigator decision is suspicious. In this respect, the combined prediction that is produced by the prediction-combination component 310 functions may comprise a binary indication of whether or not the transaction is predicted to be suspicious, a combined numerical value quantifying a predicted likelihood that the transaction is suspicious, or both, among other possibilities. Further, the manner in which the prediction-combination component 310 functions to combine the first prediction and the second prediction into the combined prediction may take various forms.

As one possibility, the prediction-combination component 310 may use a statistical technique to combine the first and second predictions, which as noted above may comprise first and second numerical values quantifying predicted likelihoods that the transaction activity underlying the given investigator decision is suspicious. For example, the prediction-combination component 310 may first determine the mean, maximum, or minimum of the first and second numerical values, which may produce a combined numerical value quantifying a predicted likelihood that the transaction is suspicious. Additionally, the prediction-combination component 310 may transform the combined numerical value into a binary indicator of whether or not the transaction activity underlying the given investigator decision is predicted to be suspicious by comparing the combined numerical value to a threshold value (e.g., a value of 0.5). In this respect, if the combined numerical value is less than the threshold value, the binary indication may be set to a value of 0 or “no,” whereas if the combined numerical value is greater than or equal to the threshold value, the binary indication may be set to a value of 1 or “yes.”

As another possibility, the prediction-combination component 310 may combine the first and second predictions using an AI model that is configured to (i) receive the first and second numerical values and (ii) based on an evaluation of the first and second numerical values, output a combined prediction. In practice, such an AI model may comprise any of various forms of AI models that may be trained by applying a machine learning process to training data, including but not limited to a regression model that is trained by a supervised machine learning process. Further, in line with the discussion above, the combined prediction that is output by such an AI model may be a binary indication of whether the transaction activity underlying the given investigator decision is predicted to be suspicious, a combined numerical value quantifying a predicted likelihood that the transaction activity underlying the given investigator decision is suspicious, or both.

Other manners of combining the first prediction and the second prediction into the combined prediction are also possible.

The prediction-combination component 310 may pass the combined prediction to the investigator-decision-validation component 312, which may generally function to determine whether or not the given investigator decision is to be flagged for quality review based on a comparison between the given investigator decision and the combined prediction that is output by the prediction-combination component 310. In this respect, if the given investigator decision matches the combined prediction (i.e., either both indicate that the transaction activity is not suspicious or both indicate that the transaction activity is suspicious), the investigator-decision-validation component 312 may determine that the given investigator decision is valid and is not to be flagged for quality review. On the other hand, if the given investigator decision does not match the combined prediction (i.e., the given investigator decision indicates that the transaction activity is not suspicious but the combined prediction indicates the transaction activity is suspicious, or vice versa), the investigator-decision-validation component 312 may determine that the given investigator decision is not valid and is to be flagged for quality review.

Further, in practice, the function of comparing the given investigator decision and the combined prediction that is output by the prediction-combination component 310 may involve transforming the combined prediction from a numerical value to a binary indication of whether the transaction activity underlying the given investigator decision is predicted to be suspicious (e.g., by comparing the numerical value to a threshold value) so as to facilitate the comparison with the given investigator decision.

After the investigator-decision-validation component 312 determines whether the given investigator decision is to be flagged for quality review, the investigator-decision-validation component 312 may then output an indication of whether the given investigator decision has been flagged for quality review, which may in turn be passed to the output interface 314.

As noted above, the first AI model 306, second AI model 308, the prediction-combination component 310, and the investigator-decision-validation component 312 may collectively define a primary evaluation path of the example architecture 300 shown in FIG. 3. Additionally, as noted above, the example architecture 300 may additionally include a secondary evaluation path that may be utilized for investigator decisions that are not flagged for quality review by the primary evaluation path (i.e., investigator decisions that match the combined prediction output by the prediction-combination component 310). As above, for purposes of illustration, the secondary evaluation path will be described below in the context of the given investigator decision, but it should be understood that in practice, the given investigator decision will typically only be passed to the secondary evaluation path for further evaluation in a scenario where the given investigator decision has not been flagged for quality review by the primary evaluation path—and more particularly, a scenario where both the combined prediction and the investigator decision indicate that the transaction activity underlying the investigator decision is not suspicious.

The secondary evaluation path may begin with the third AI model 316, which may comprise an instance of the first type of AI model that is configured to (i) receive the third set of feature data for the transaction activity underlying the given investigator decision that takes the form of structured feature data and (ii) based on an evaluation of the third set of feature data, generate and output a third prediction of whether the transaction activity underlying the given investigator decision is suspicious.

The third set of feature data may include feature values for a second set of structured feature variables, which may take any of various forms. For instance, in one implementation, the second set of structured feature variables may include (i) one or more account-holder-attribute feature variables (e.g., an indication of a demographic characteristic of the account holder, an indication of an account holder's creditworthiness, etc.), (ii) one or more transaction-activity feature variables (e.g., indications of types of transactions that have occurred over specified periods of time in connection with one or more accounts held by the account holder, indications of classifications associated with parties to as, indications of credit metrics for the one or more accounts, etc.), and (iii) one or more account-activity feature variables (e.g., indications of changes to contact information, etc.). However, unlike the first set of feature data, the third set of feature data may not include any investigator-decision feature variables. The second set of structured feature variables may also take other forms.

Further, the third prediction that is output by the third AI model 316 may take various forms, and in one implementation, the third prediction may comprise (i) a third numerical value that quantifies a third predicted likelihood that the transaction activity underlying the given investigator decision is suspicious, (ii) a binary indication of whether or not the transaction activity is predicted to be suspicious, or (iii) both.

The third AI model 316 may also take other forms as well.

As shown in FIG. 3, the third AI model 316 may then pass the third prediction to the prediction-validation component 318 of the example architecture 300.

The prediction-validation component 318 may generally function to determine whether or not the given investigator decision is to be flagged for quality review based on a comparison between the combined prediction output by the prediction-combination component 310 and the third prediction output by the third AI model 316. In this respect, if the combined prediction and the third prediction match (i.e., either both indicate that the transaction activity is not suspicious or both indicate that the transaction activity is suspicious), the prediction-validation component 318 may determine that the combined prediction is valid and that the given investigator decision is not to be flagged for quality review by the secondary evaluation path. On the other hand, if the combined prediction and the third prediction do not match (i.e., the combined prediction indicates that the transaction activity is not suspicious but the third prediction indicates the transaction activity is suspicious, or vice versa), the prediction-validation component 318 may determine that the combined prediction is not valid and that the given investigator decision is to be flagged for quality review by the secondary evaluation path.

In practice, the function of comparing the combined prediction output by the prediction-combination component 310 and the third prediction output by the third AI model 316 may involve transforming one or both of the predictions from a numerical value to a binary indication of whether the transaction activity underlying the given investigator decision is predicted to be suspicious (e.g., by comparing the numerical value to a threshold value) so as to facilitate the comparison between the combined prediction and the third prediction. After the prediction-validation component 318 determines whether the given investigator decision is to be flagged for quality review, the prediction-validation component 318 may then output an indication of whether the given investigator decision has been flagged for quality review, which may in turn be passed to the output interface 314.

As noted above and shown in FIG. 3, the example architecture 300 of the investigator-decision-analysis component 230 may further include the explainability component 320, which may generally function to generate explanations for the predictions output by one or more of the AI models of the example architecture 300.

For instance, in at least some implementations, the explainability component 320 may function to generate explanations for the predictions output by the first AI model 306. In this respect, the function of generating explanations for a prediction output by the first AI model 306 may involve utilizing a model explainability technique (sometimes referred to as a model interpretability technique) to quantify the contributions of the feature variables that define the first AI model's input to the prediction that is generated and output by the first AI model 306. In other words, the model explainability technique may determine an extent to which each of the first AI model's feature variables influences the prediction that is generated and output by the first AI model 306. For instance, after the first AI model 306 receives the first set of feature data for the transaction activity underlying the given investigator decision that includes values for the first set of structured feature variables and then generates and outputs the first prediction of whether the transaction activity underlying the given investigator decision is suspicious, the explainability component 320 may utilize a model explainability technique to quantify the contributions of the different feature variables to the first prediction, where some of the feature variables may have had a larger impact on the first AI model's prediction of whether the transaction activity underlying the given investigator decision is suspicious, while others of the feature variables may have had a smaller impact on the first AI model's prediction of whether the transaction activity underlying the given investigator decision is suspicious. In this respect, the contributions of the feature variables to the prediction could be quantified in terms of a set of feature contribution values (or “scores”) for the feature variables.

The model explainability technique that is utilized by the explainability component 320 to quantify the contributions of the first AI model's feature variables to the first AI model's predictions may take any of various forms, examples of which may include a game-theoretic explainability technique (e.g., a technique that determines or approximates Shapley values, Owen values, Banzhaf-Owen values, etc.), of which SHapley Additive exPlanations (SHAP) is a particular example, a Local Interpretable Model-agnostic Explanations (LIME) technique, a plot-based explainer technique (e.g., Partial Dependence Plots (PDP), Individual Conditional Expectation (ICE) plots, Accumulated Local Effects (ALE), etc.), a gradient-based technique, and/or a layer wise relevance propagation (LRP) technique, among other possible types of model explainability techniques that may be utilized to generate explanations for an AI model that is configured to receive structured feature data.

Using the foregoing functionality, the explainability component 320 may determine a respective set of feature contribution values for each prediction that is generated and output by the first AI model 306, which may then be utilized to evaluate the extent to which each of the feature variable contributed to each of the first AI model's predictions. For instance, if the explainability component 320 is configured to use a SHAP technique to explain the predictions output by the first AI model 306, then for each such prediction, the explainability component 320 may generate a respective set of feature contribution values corresponding to the feature variables of the first AI model 306, where (i) positive SHAP values indicate feature variables that had a positive contribution on the outcome that was predicted by the first AI model 306 and (ii) negative SHAP values indicate feature variables that had a negative contribution on the outcome that was predicted by the first AI model 306. To illustrate with a simplified example, if the first AI model 306 outputs a prediction that the transaction activity underlying the given investigator decision is suspicious and the explainability component 320 then determines corresponding SHAP values for five feature variables having values of 0.2 for the first feature variable, −0.7 for the second feature variable, 0.8 for the third feature variable, 0.4 for the fourth feature variable, and −0.3 for the fifth feature variable, then this indicates that the third feature variable was the largest positive contributor to the prediction, the fourth feature variable was the second-largest positive contributor to the prediction, and the first feature variable was the third-largest positive contributor to the prediction, whereas the second feature variable was the largest negative contributor to the prediction and the fifth feature variable was the second-largest negative contributor to the prediction. However, it should be understood that in practice, the first AI model 306 is likely to have tens or even hundreds of features for which feature contribution values may be determined by the explainability component 320.

Further, based on the respective set of feature contribution values that is determined for each prediction, the explainability component 320 may also identify a first subset of the feature variables that had the most positive contribution to the outcome predicted by the first AI model 306 (e.g., the top five or top ten feature variables in terms of positive contribution) and perhaps also a second subset of the feature variables that had the most negative contribution to the outcome predicted by the first AI model 306 (e.g., the top five or top ten feature variables in terms of negative contribution), among other functions that the explainability component 320 may perform based on the determined feature contribution values.

The function of generating explanations for a prediction output by the first AI model 306 may take other forms as well.

Additionally or alternatively, in at least some implementations, the explainability component 320 may function to generate explanations for the predictions output by the second AI model 308. In this respect, the function of generating explanations for a prediction output by the second AI model 308 may involve utilizing a model explainability technique (sometimes referred to as a model interpretability technique) to quantify the contributions of textual segments (e.g., individual words or phrases) appearing within textual feature data provided as input to the second AI model 308 to the prediction that is generated and output by the second AI model 308. In other words, the model explainability technique may determine an extent to which each of the textual segments appearing within the textual feature data (which are considered the “features” for explainability purposes) influences the prediction that is generated and output by the second AI model 308. For instance, after the second AI model 308 receives the second set of feature data for the transaction activity underlying the given investigator decision that comprises textual feature data and then generates and outputs the second prediction of whether the transaction activity underlying the given investigator decision is suspicious, the explainability component 320 may utilize a model explainability technique to quantify the contributions of the different textual segments appearing within the textual feature data to the second prediction, where some of the textual segments may have had a larger impact on the second AI model's prediction of whether the transaction activity underlying the given investigator decision is suspicious, while others of the textual segments may have had a smaller impact on the second AI model's prediction of whether the transaction activity underlying the given investigator decision is suspicious. In this respect, the contributions of the textual segments to the prediction could be quantified in terms of a set of segment contribution values (or “scores”) for the textual segments.

The model explainability technique that is utilized by the explainability component 320 to quantify the contributions of the textual segments appearing within the textual feature data provided as input to the second AI model to the prediction that is generated and output by the second AI model 308 may take any of various forms, examples of which may include a game-theoretic explainability technique (e.g., a technique that determines or approximates Shapley values, Owen values, Banzhaf-Owen values, etc.), of which SHAP is a particular example, a LIME technique, a plot-based explainer technique (e.g., PDP, ICE, ALE, etc.), a gradient-based technique, and/or an LRP technique, among other possible types of model explainability techniques that may be utilized to generate explanations for an AI model that is configured to receive unstructured feature data comprising textual segments.

Using the foregoing functionality, the explainability component 320 may determine a respective set of segment contribution values for each prediction that is generated and output by the second AI model 308, which may then be utilized to evaluate the extent to which each of the textual segments appearing within the textual feature data contributed to each of the second AI model's predictions. For instance, if the explainability component 320 is configured to use a SHAP technique to explain the predictions output by the second AI model 308, then for each such prediction, the explainability component 320 may generate a respective set of segment contribution values corresponding to textual segments appearing within the textual feature data, where (i) positive SHAP values indicate textual segments that had a positive contribution on the outcome that was predicted by the second AI model 308 and (ii) negative SHAP values indicate textual segments that had a negative contribution on the outcome that was predicted by the second AI model 308. To illustrate with a simplified example, if the second AI model outputs a prediction that the transaction activity underlying the given investigator decision is suspicious and the explainability component 320 then determines corresponding SHAP values for five textual segments having values of 0.2 for the first textual segment, −0.7 for the second textual segment, 0.8 for the third textual segment, 0.4 for the fourth textual segment, and −0.3 for the fifth textual segment, then this indicates that the third textual segment was the largest positive contributor to the prediction, the fourth textual segment was the second-largest positive contributor to the prediction, and the first textual segment was the third-largest positive contributor to the prediction, whereas the second textual segment was the largest negative contributor to the prediction and the fifth textual segment was the second-largest negative contributor to the prediction. However, it should be understood that in practice, the second AI model 308 may receive textual feature data comprising tens or even hundreds of textual segments for which segment contribution values may be determined by the explainability component 320.

Further, based on the respective set of segment contribution values that is determined for each prediction, the explainability component 320 may also identify a first subset of the textual segments that had the most positive contribution to the outcome predicted by the second AI model 308 (e.g., the top five or top ten textual segments in terms of positive contribution) and perhaps also a second subset of the textual segments that had the most negative contribution to the outcome predicted by the second AI model 308 (e.g., the top five or top ten textual segments in terms of negative contribution), among other functions that the explainability component 320 may perform based on the determined segment contribution values.

Although not shown in FIG. 3, the explainability component 320 may also optionally generate explanations for the predictions that are output by the third AI model 316.

In practice, the explainability component 320 could be configured to either (i) generate explanations for all investigator decisions that are evaluated or (ii) generate explanations for investigator decisions that are flagged for quality review (but not investigator decisions that are not flagged for quality review).

To the extent that the explainability component 320 generates explanations for one or both of the first and/or second predictions generated by the first AI model 306 and/or the second AI model 308 for the given investigator decision, the explainability component 320 may then pass the generated explanations to the output interface 314.

The output interface 314 may generally function to (i) receive indications of investigator decisions that have been flagged for quality review by the validation components 312 and 318 (along with associated explanations generated by the explainability component 320 generates, (ii) generate data records for the investigator decisions that have been flagged for quality review, which may be referred to herein as “quality-review records,” and (iii) store the quality-review records (e.g., in a data storage layer of the back-end computing platform 102) for future access and use by other components of the example software-based pipeline 200 and/or send the quality-review records to other components of the example software-based pipeline 200, such as the quality-review component 240. For instance, to the extent that the given investigator decision is flagged for quality review by either the investigator-decision-validation component 312 or the prediction-validation component 318, then as noted above, an indication that the given investigator decision has been flagged for quality review may be passed to the output interface 314 along with associated explanations generated by the explainability component 320. In turn, the output interface 314 may function to generate a quality-review data record for the given investigator decision, which may be stored and/or sent to other components of the example software-based pipeline 200.

The data that is included in the quality-review record for the given investigator decision may take various forms, examples of which may include data about the transaction activity (e.g., data similar to what was included in the alert for the transaction activity), data about the given investigator decision for the transaction activity (e.g., an indication of the investigator decision and perhaps also certain investigator-decision data), an indication of prediction(s) and/or validation determination(s) made by the investigator-decision-analysis component 230, and explanation data for the given investigator decision (e.g., the top feature variables and/or textual segments that contributed positively and/or negatively to the predictions output by the first AI model 306 and/or the second AI model 308), among other possibilities.

In some implementations, the output interface 314 may also function to compile the quality-review records for different investigator decisions together into a single data structure (e.g., an XLSX file), in which case the output interface 314 may store and/or send the generated quality-review records in batches rather than on a record-by-record basis.

The architecture of the investigator-decision-analysis component 230 may take various other forms as well, including but not limited to the possibility that functional components may be added to the example architecture 300, functional components may be removed from the example architecture 300, functional components within the example architecture 300 may combined together, functional components within the example architecture 300 may be split into multiple sub-components, and/or functions described as being carried out by one functional component above may instead be carried out by a different functional component described above, among various other possibilities.

Referring back to FIG. 2, the quality-review component 240 of the example software-based pipeline 200 may generally function to (i) receive quality-review records for investigator decisions that the investigator-decision-analysis component 230 has flagged for review and (ii) present the flagged investigator decisions to quality-review analysts via a GUI referred to herein as a “quality-review GUI,” and (iii) receive analyst input regarding the flagged investigator decisions via the quality-review GUI.

To begin, the quality-review component 240 may receive quality-review records for flagged investigator decisions by loading quality-review records from a data storage layer of the back-end computing platform 102, receiving quality-review records from the investigator-decision-analysis component 230, and/or obtaining quality-review records from some other source. In turn, the quality-review component 240 may (i) receive a request from a given analyst to access the quality-review GUI, which may be embodied in the form of one or more messages that are sent by a client device associated with the given analyst over a network-based communication path to the back-end computing platform 102, and (ii) in response to receiving the request, cause the quality-review GUI to be presented to given analyst, which may involve the back-end computing platform 102 sending one or more messages over the network-based communication path that instruct and cause the client device to render the quality-review GUI.

After being presented with the quality-review GUI, the given analyst may begin to review certain of the flagged investigator decisions via the given analyst's client device. For instance, the given analyst may utilize the client device to select an investigator decision within the quality-review GUI, which may cause the quality-review GUI to present the given analyst with further details regarding the selected investigator decision, including but not limited to details that are included within the quality-review record for the selected investigator decision—such as data about the transaction activity underlying the selected investigator decision (e.g., data similar to what was included in the alert for the transaction activity), data about the selected investigator decision for the transaction activity (e.g., an indication of the selected investigator decision and perhaps also certain investigator-decision data), an indication of prediction(s) and/or validation determination(s) made by the investigator-decision-analysis component 230, and explanation data for the selected investigator decision (e.g., the top feature variables and/or textual segments that contributed positively and/or negatively to the predictions output by the first AI model 306 and/or the second AI model 308), among other possibilities.

After the given analyst has completed his or her review of the selected investigator decision, the given analyst may reach a decision as to whether the given analyst agrees or disagrees with the selected investigator decision (e.g., whether the given analyst believes the selected investigator decision was compliant or non-compliant), which may be referred to herein as an “quality-review conclusion,” and may then use the client device to input, into the quality-review GUI, (i) an indication of the quality-review conclusion for the selected investigator decision along with (ii) other associated quality-review data (e.g., natural-language and/or free-form notes that indicate reasoning and/or facts on which the quality-review conclusion is based).

In practice, the client device of the given analyst may then send the given analyst's input to the back-end computing platform 102 over the network-based communication path, and the quality-review component 240 may thereafter receive the given analyst's input comprising the indication of the quality-review conclusion and the associated quality-review data (e.g., notes) for the selected investigator decision.

The foregoing process may be repeated for any of various investigator decisions that may be accessed and reviewed by any of various analysts.

The quality-review component 240 may further function to (i) store the received indications of the quality-review conclusions and associated quality-review data (e.g., in a data storage layer of the back-end computing platform 102) for future access and use by other components of the example software-based pipeline 200 and/or (ii) send the received indications of the quality-review conclusions and associated quality-review data to other software components of the back-end computing platform 102 and/or to other computing platforms.

The indications of the quality-review conclusions (and associated quality-review data) that are received by the quality-review component 240 may thereafter be utilized for any of various purposes.

As one possibility, if the quality-review conclusion for an investigator decision indicates that the investigator decision was non-compliant, the example software-based pipeline 200 (and/or some other software component of back-end computing platform 102) may re-open the investigation and re-assign the transaction activity underlying the investigator decision to an investigator, who may conduct a further review of the transaction activity to determine whether or not to change the investigator decision. In practice, the investigator's further review of the alert may be performed via the transaction review GUI described above or via some other GUI. While performing the further review, the investigator may be presented with some or all of the data associated with the transaction activity that was presented when the investigator decision was initially made, along with the quality-review conclusion and the quality-review data, among other possibilities. Further, after completing the further review, the investigator may input an indication of whether or not the investigator believes that the investigator decision should be changed.

As another possibility, the example software-based pipeline 200 (and/or some other software component of back-end computing platform 102) may use the quality-review conclusions to generate any of various output data that may be presented to a user.

For instance, one type of output data that may be generated based on the quality-review conclusions may take the form of a report that lists investigator decisions that have been flagged for quality review. Another type of output data that may be generated based on the quality-review conclusions may take the form of statistical data regarding the investigator decisions, such as an extent (e.g., a percentage, a ratio, etc.) of investigator decisions that have been found to be non-compliant by quality-review analysts and/or an extent (e.g., a percentage, a ratio, etc.) of investigator decisions that have been both (i) found to be non-compliant by quality-review analysts and (ii) confirmed to be non-compliant by investigators during a further review, among other possible examples of statistical data regarding the investigator decisions that may be generated based on the quality-review conclusions.

As yet another possibility, the example software-based pipeline 200 (and/or some other software component of back-end computing platform 102) may use quality-review conclusions and/or further input from investigators to assess the accuracy of the one or more AI models that are utilized by the investigator-decision-analysis component 230 to evaluate investigator decisions, and if that assessment indicates that an AI model is not sufficiently accurate, the example software-based pipeline 200 may initiate a process for updating the AI model (e.g., by updating the AI model parameters and/or re-training the AI model). For instance, if quality-review analysts and/or investigators disagree with a prediction made by an AI model, this may be indicative of a prediction accuracy issue that should be resolved.

As still another possibility, the quality-review conclusions (and associated quality-review data) may be utilized to provide focused training of FIU investigators (e.g., FIU investigators who authored investigator decisions that were found to have errors) and/or to guide the evaluation (and potential update) of FIU investigation procedures.

The indications of the quality-review conclusions (and associated quality-review data) that are received by the quality-review component 240 may thereafter be utilized for other purposes as well.

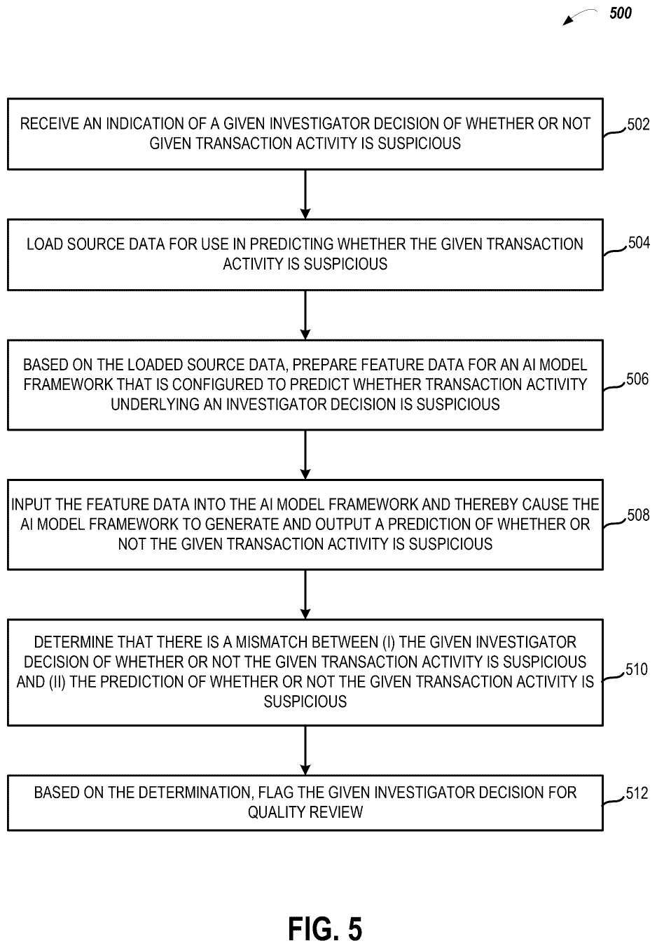

One possible example of functionality 500 that may be carried out in accordance with the disclosed software technology will now be described with reference to the flow chart of FIG. 5. In practice, the functionality 500 of FIG. 5 may be encoded in the form of program instructions that are executable by one or more processors of a computing platform, and for purposes of illustration, the functionality 500 of FIG. 5 is described as being carried out by the back-end computing platform 102 of FIG. 1, but it should be understood that the functionality 500 of FIG. 5 may be carried out by any one or more computing platforms that are capable of being installed with software for performing the functions described below. Further, it should be understood that the functionality 500 of FIG. 5 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

In line with discussion above, the functionality 500 may begin at block 502 with the back-end computing platform 102 receiving an indication of a given investigator decision of whether or not given transaction activity is suspicious.

At block 504, the computing platform 102 loads source data for use in predicting whether the given transaction activity is suspicious, where such source data may take any of the various forms described above.

At block 506, the computing platform 102 prepares, based on the loaded source data, feature data for a AI model framework that is configured to predict whether transaction activity underlying an investigator decision is suspicious.

In some examples, preparing the feature data may comprise generating structured feature data comprising values for a first set of structured feature variables that provide information about (i) an account holder involved in the given transaction activity and (ii) the given investigator decision. Further, in some examples, preparing the feature data may comprise generating unstructured feature data comprising textual data generated in connection with the given investigator decision. Further yet, in some examples, preparing the feature data may comprise generating structured feature data comprising values for a second set of structured feature variables that provide information about the account holder involved in the activity, but do not provide information about the given investigator decision.

At block 508, the computing platform 102 inputs the feature data into the AI model framework and thereby causes the AI model framework to generate and output a prediction of whether or not the given transaction activity is suspicious.

In some examples, the AI model framework comprises a first AI model and inputting the feature data into the AI model framework and thereby causing the AI model framework to generate and output the prediction comprises inputting the values for the first set of structured feature variables into the first AI model, thereby causing the first AI model to generate and output a first prediction of whether the given transaction activity is suspicious.

Further, in some examples, the AI model framework comprises a second AI model and inputting the feature data into the AI model framework and thereby causing the AI model framework to generate and output the prediction comprises inputting the textual data into the second AI model, thereby causing the second AI model to generate and output a second prediction of whether the given transaction activity is suspicious.

Further still, in some examples, inputting the feature data into the AI model framework and thereby causing the AI model framework to generate and output a prediction of whether or not the given transaction activity is suspicious comprises causing the AI model framework to combine the first prediction and the second prediction into a combined prediction.

Further still, in some examples, the AI model framework comprises a third AI model and inputting the feature data into the AI model framework and thereby causing the AI model framework to generate and output the prediction comprises inputting the values for the second set of structured feature variables into the third AI model, thereby causing the third AI model to generate and output a third prediction of whether the given transaction activity is suspicious.

At block 510, the computing platform 102 determines that there is a mismatch between (i) the given investigator decision of whether or not the given transaction activity is suspicious and (ii) the prediction of whether or not the given transaction activity is suspicious.

In some examples, the combined prediction is the prediction of whether or not the given transaction activity is suspicious, and determining that there is a mismatch between (i) the given investigator decision of whether or not the given transaction activity is suspicious and (ii) the prediction of whether or not the given transaction activity is suspicious involves determining that the there is a mismatch between (i) the given investigator decision of whether or not the given transaction activity is suspicious and (ii) the combined prediction.

Further, in some examples, the third prediction is the prediction of whether or not the given transaction activity is suspicious, and determining that there is a mismatch between (i) the given investigator decision of whether or not the given transaction activity is suspicious and (ii) the prediction of whether or not the given transaction activity is suspicious comprises: determining that there is a match between (i) the given investigator decision of whether or not the given transaction activity is suspicious and (ii) the combined prediction; and determining that there is a mismatch between (i) the combined prediction and (ii) the third prediction.

At block 512, the computing platform 102 flags the given investigator decision for quality review based on the determination

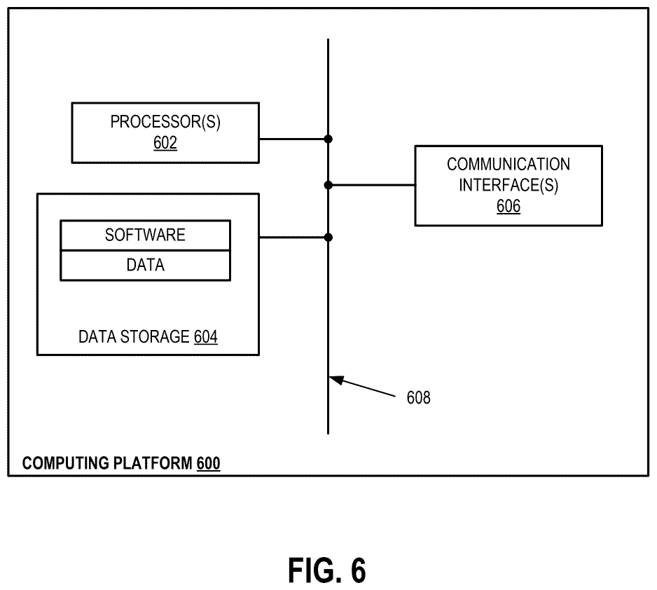

Turning now to FIG. 6, a simplified block diagram is provided to illustrate some structural components that may be included in an example computing platform 600 that may be configured to perform some or all of the platform functions disclosed herein. At a high level, the example computing platform 600 may generally comprise any one or more computer systems (e.g., one or more servers) that collectively include one or more processors 602, data storage 604, and one or more communication interfaces 606, all of which may be communicatively linked by a communication link 608 that may take the form of a system bus, a communication network such as a public, private, or hybrid cloud, or some other connection mechanism. Each of these components may take various forms.

For instance, the one or more processors 602 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 602 could comprise processing components that are distributed across a plurality of physical computing devices connected via a network, such as a computing cluster of a public, private, or hybrid cloud.

In turn, the data storage 604 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 604 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 6, the data storage 604 may be capable of storing both (i) program instructions that are executable by the one or more processors 602 such that the example computing platform 600 is configured to perform any of the various functions disclosed herein (including but not limited to any of the platform functions discussed above), and (ii) data that may be received, derived, or otherwise stored by the example computing platform 600.

The one or more communication interfaces 606 may comprise one or more interfaces that facilitate communication between the example computing platform 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 600 may additionally have an I/O interface that includes or provides connectivity to I/O components that facilitate user interaction with the example computing platform 600, such as a keyboard, a mouse, a trackpad, a display screen, a touch-sensitive interface, a stylus, a virtual-reality headset, and/or one or more speaker components, among other possibilities.

It should be understood that the example computing platform 600 is one example of a computing platform that may be used with the embodiments described herein. Numerous other arrangements are possible and contemplated herein. For instance, in other embodiments, the example computing platform 600 may include additional components not pictured and/or more or less of the pictured components.

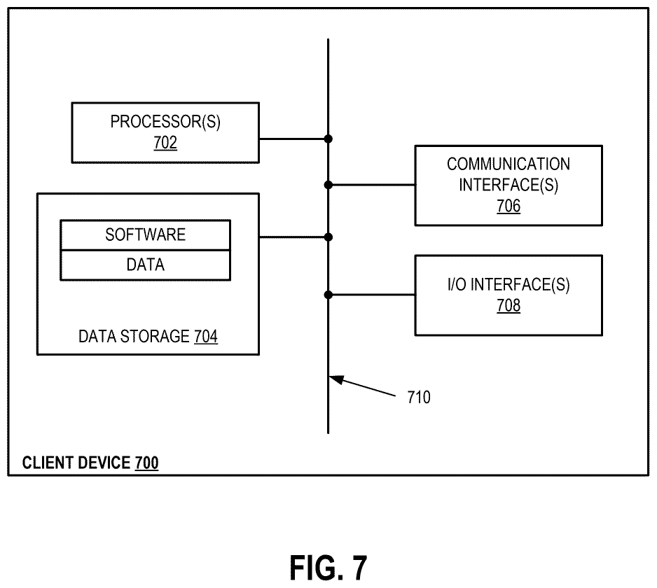

Turning next to FIG. 7, a simplified block diagram is provided to illustrate some structural components that may be included in an example client device 700 that may be configured to perform some or all of the client-device functions disclosed herein. At a high level, the example client device 700 may include one or more processors 702, data storage 704, one or more communication interfaces 706, and an I/O interface 708, all of which may be communicatively linked by a communication link 710 that may take the form of a system bus and/or some other connection mechanism. Each of these components may take various forms.

For instance, the one or more processors 702 of the example client device 700 may comprise one or more processor components, such as one or more CPUs, GPUs, ASICs, DSPs, and/or programmable logic devices such as FPGAs, among other possible types of processing components.

In turn, the data storage 704 of the example client device 700 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 7, the data storage 704 may be capable of storing both (i) program instructions that are executable by the one or more processors 702 of the example client device 700 such that the example client device 700 is configured to perform any of the various functions disclosed herein (including but not limited to any of the client-device functions discussed above), and (ii) data that may be received, derived, or otherwise stored by the example client device 700.

The one or more communication interfaces 706 may comprise one or more interfaces that facilitate communication between the example client device 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 708 may generally take the form of (i) one or more input interfaces that are configured to receive and/or capture information at the example client device 700 and (ii) one or more output interfaces that are configured to output information from the example client device 700 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 708 may include or provide connectivity to output components such as a display screen and/or an audio speaker, among other possibilities.

It should be understood that the example client device 700 is one example of a client device that may be used with the example embodiments described herein. Numerous other arrangements are possible and contemplated herein. For instance, in other embodiments, the example client device 700 may include additional components not pictured and/or more or fewer of the pictured components.

We claim:

1. A computing platform comprising:
at least one communication interface;
at least one processor;
at least one non-transitory computer-readable medium; and
program instructions stored on the at least one non-transitory computer-readable medium that, when executed by the at least one processor, cause the computing platform to:
receive an indication of a given investigator decision of whether or not given transaction activity is suspicious;
load source data for use in predicting whether the given transaction activity is suspicious;
based on the loaded source data, prepare feature data for an artificial intelligence (AI) model framework that is configured to predict whether transaction activity underlying an investigator decision is suspicious;
input the feature data into the AI model framework and thereby cause the AI model framework to generate and output a prediction of whether or not the given transaction activity is suspicious;
determine that there is a mismatch between (i) the given investigator decision of whether or not the given transaction activity is suspicious and (ii) the prediction of whether or not the given transaction activity is suspicious; and
based on the determination, flag the given investigator decision for quality review.

2. The computing platform of claim 1, wherein the program instructions that, when executed by the at least one processor, cause the computing platform to prepare the feature data for the AI model framework comprise program instructions that, when executed by the at least one processor, cause the computing platform to:
generate structured feature data comprising values for a first set of structured feature variables that provide information about (i) an account holder involved in the given transaction activity and (ii) the given investigator decision; and
generate unstructured feature data comprising textual data generated in connection with the given investigator decision.

3. The computing platform of claim 2, wherein the AI model framework comprises a first AI model and a second AI model, and wherein the program instructions that, when executed by the at least one processor, cause the computing platform to input the feature data into the AI model framework and thereby cause the AI model framework to generate and output the prediction comprise program instructions that, when executed by the at least one processor, cause the computing platform to:
input the values for the first set of structured feature variables into the first AI model, thereby causing the first AI model to generate and output a first prediction of whether the given transaction activity is suspicious; and
input the textual data into the second AI model, thereby causing the second AI model to generate and output a second prediction of whether the given transaction activity is suspicious.

4. The computing platform of claim 3, wherein the program instructions that, when executed by the at least one processor, cause the computing platform to input the feature data into the AI model framework and thereby cause the AI model framework to generate and output the prediction further comprise program instructions that, when executed by the at least one processor, cause the computing platform to:
combine the first prediction and the second prediction into a combined prediction.

5. The computing platform of claim 4, wherein the program instructions that, when executed by the at least one processor, cause the computing platform to prepare the feature data for the AI model framework comprise program instructions that, when executed by the at least one processor, cause the computing platform to:
generate structured feature data comprising values for a second set of structured feature variables that provide information about the account holder involved in the given transaction activity, but do not provide information about the given investigator decision.

6. The computing platform of claim 5, wherein the AI model framework comprises a third AI model, and wherein the program instructions that, when executed by the at least one processor, cause the computing platform to input the feature data into the AI model framework and thereby cause the AI model framework to generate and output the prediction comprise program instructions that, when executed by the at least one processor, cause the computing platform to:
input the values for the second set of structured feature variables into the third AI model, thereby causing the third AI model to generate and output a third prediction of whether the given transaction activity is suspicious.

7. The computing platform of claim 6, wherein the third prediction is the prediction of whether or not the given transaction activity is suspicious, and wherein the program instructions that, when executed by the at least one processor, cause the computing platform to determine that there is a mismatch between (i) the given investigator decision of whether or not the given transaction activity is suspicious and (ii) the prediction of whether or not the given transaction activity is suspicious comprise program instructions that, when executed by the at least one processor, cause the computing platform to:
determine that there is a match between (i) the given investigator decision of whether or not the given transaction activity is suspicious and (ii) the combined prediction; and
determine that there is a mismatch between (i) the combined prediction and (ii) the third prediction.

8. A non-transitory computer-readable medium, wherein the non-transitory computer-readable medium is provisioned with program instructions that, when executed by at least one processor, cause a computing platform to:
receive an indication of a given investigator decision of whether or not given transaction activity is suspicious;
load source data for use in predicting whether the given transaction activity is suspicious;
based on the loaded source data, prepare feature data for an artificial intelligence (AI) model framework that is configured to predict whether transaction activity underlying an investigator decision is suspicious;
input the feature data into the AI model framework and thereby cause the AI model framework to generate and output a prediction of whether or not the given transaction activity is suspicious;
determine that there is a mismatch between (i) the given investigator decision of whether or not the given transaction activity is suspicious and (ii) the prediction of whether or not the given transaction activity is suspicious; and
based on the determination, flag the given investigator decision for quality review.

9. The non-transitory computer-readable medium of claim 8, wherein the program instructions that, when executed by the at least one processor, cause the computing platform to prepare the feature data for the AI model framework comprise program instructions that, when executed by the at least one processor, cause the computing platform to:
generate structured feature data comprising values for a first set of structured feature variables that provide information about (i) an account holder involved in the given transaction and (ii) the given investigator decision; and
generate unstructured feature data comprising textual data generated in connection with the given investigator decision.

10. The non-transitory computer-readable medium of claim 9, wherein the AI model framework comprises a first AI model and a second AI model, and wherein the program instructions that, when executed by the at least one processor, cause the computing platform to input the feature data into the AI model framework and thereby cause the AI model framework to generate and output the prediction comprise program instructions that, when executed by the at least one processor, cause the computing platform to:
input the values for the first set of structured feature variables into the first AI model, thereby causing the first AI model to generate and output a first prediction of whether the given transaction activity is suspicious; and
input the textual data into the second AI model, thereby causing the second AI model to generate and output a second prediction of whether the given transaction activity is suspicious.

11. The non-transitory computer-readable medium of claim 10, wherein the program instructions that, when executed by the at least one processor, cause the computing platform to input the feature data into the AI model framework and thereby cause the AI model framework to generate and output the prediction further comprise program instructions that, when executed by the at least one processor, cause the computing platform to:
combine the first prediction and the second prediction into a combined prediction.

12. The non-transitory computer-readable medium of claim 11, wherein the program instructions that, when executed by the at least one processor, cause the computing platform to prepare the feature data for the AI model framework comprise program instructions that, when executed by the at least one processor, cause the computing platform to:
generate structured feature data comprising values for a second set of structured feature variables that provide information about the account holder involved in the transaction, but do not provide information about the given investigator decision.

13. The non-transitory computer-readable medium of claim 12, wherein the AI model framework comprises a third AI model, and wherein the program instructions that, when executed by the at least one processor, cause the computing platform to input the feature data into the AI model framework and thereby cause the AI model framework to generate and output the prediction comprise program instructions that, when executed by the at least one processor, cause the computing platform to:
input the values for the second set of structured feature variables into the third AI model, thereby causing the third AI model to generate and output a third prediction of whether the given transaction activity is suspicious.

14. The non-transitory computer-readable medium of claim 13, wherein the third prediction is the prediction of whether or not the given transaction activity is suspicious, and wherein the program instructions that, when executed by the at least one processor, cause the computing platform to determine that there is a mismatch between (i) the given investigator decision of whether or not the given transaction activity is suspicious and (ii) the prediction of whether or not the given transaction activity is suspicious comprise program instructions that, when executed by the at least one processor, cause the computing platform to:
determine that there is a match between (i) the given investigator decision of whether or not the given transaction activity is suspicious and (ii) the combined prediction; and
determine that there is a mismatch between (i) the combined prediction and (ii) the third prediction.

15. A method carried out by a computing platform, the method comprising:
receiving an indication of a given investigator decision of whether or not given transaction activity is suspicious;
loading source data for use in predicting whether the given transaction activity is suspicious;
based on the loaded source data, preparing feature data for an artificial intelligence (AI) model framework that is configured to predict whether transaction activity underlying an investigator decision is suspicious;
inputting the feature data into the AI model framework and thereby causing the AI model framework to generate and output a prediction of whether or not the given transaction activity is suspicious;
determining that there is a mismatch between (i) the given investigator decision of whether or not the given transaction activity is suspicious and (ii) the prediction of whether or not the given transaction activity is suspicious; and
based on the determination, flagging the given investigator decision for quality review.

16. The method of claim 15, wherein preparing the feature data for the AI model framework comprises:
generating structured feature data comprising values for a first set of structured feature variables that provide information about (i) an account holder involved in the given transaction and (ii) the given investigator decision; and
generating unstructured feature data comprising textual data generated in connection with the given investigator decision.

17. The method of claim 16, wherein the AI model framework comprises a first AI model and a second AI model, and wherein inputting the feature data into the AI model framework and thereby causing the AI model framework to generate and output the prediction comprises:
inputting the values for the first set of structured feature variables into the first AI model, thereby causing the first AI model to generate and output a first prediction of whether the given transaction activity is suspicious; and
inputting the textual data into the second AI model, thereby causing the second AI model to generate and output a second prediction of whether the given transaction activity is suspicious.

18. The method of claim 17, wherein inputting the feature data into the AI model framework and thereby causing the AI model framework to generate and output the prediction comprises:
combining the first prediction and the second prediction into a combined prediction.

19. The method of claim 18, wherein preparing the feature data for the AI model framework comprises:
generating structured feature data comprising values for a second set of structured feature variables that provide information about the account holder involved in the transaction, but do not provide information about the given investigator decision.

20. The method of claim 19, wherein the AI model framework comprises a third AI model, and wherein inputting the feature data into the AI model framework and thereby causing the AI model framework to generate and output the prediction comprises:
inputting the values for the second set of structured feature variables into the third AI model, thereby causing the third AI model to generate and output a third prediction of whether the given transaction activity is suspicious.
